(19) United States
(12) Patent Application Publication
(10) Pub. No.: US 2019/0095787 A1
(43) Pub. Date: Mar. 28, 2019

(54) SPARSE CODING BASED CLASSIFICATION

(71) Applicants: Hsiang Tsung Kung, Santa Clara, CA (US); Chit Kwan Lin, NEW YORK, NY (US); Gautham N. Chinya, HILLSBORO, OR (US)

(72) Inventors: Hsiang Tsung Kung, Santa Clara, CA (US); Chit Kwan Lin, NEW YORK, NY (US); Gautham N. Chinya, HILLSBORO, OR (US)

(21) Appl. No.: 15/717,478

(22) Filed: Sep. 27, 2017

(51) Int. Cl. G06N 3/08; G06N 3/04

(52) U.S. Cl. CPC G06N 3/08; G06N 3/04

(57) ABSTRACT

System and techniques for sparse coding based classification are described herein. A sample of a first type of data may be obtained and encoded to create a sparse coded sample. A dataset may be searched using the sparse coded sample to locate a segment set of a second type of data. An instance of the second type of data may then be created using the segment set.

### TECHNICAL FIELD

Embodiments described herein generally relate to artificial intelligence and more specifically to sparse coding based classification.

### BACKGROUND

Artificial intelligence is a field concerned with developing artificial systems to perform cognitive tasks that have traditionally required a living actor, such as a person. Of the variety of aspects of the artificial intelligence field, intelligent agents are systems that perceive the environment in some way and take actions based on that perception. Interaction with intelligent agents may occur via the environment (e.g., providing environmental data upon which the intelligent act may act) or via direct manipulation of the intelligent agent decision making process (e.g., adjusting weights of a neural network without providing input to input neurons).

Classification or regression analysis is an aspect of many artificial intelligence systems. Classification generally involves the transformation of sensor data into semantically imbued constructs upon which further action may be taken. For example, an image of a person may be captured by a camera. Analysis (e.g., segmentation, detection, etc.) may be performed on the image to identify portions of the image that correspond to, for example, the person's face. Classification may also be used to identify the person from the image. Once the classification is complete, the result may be used to perform additional actions, such as authenticate an identified person for access to a building.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for sparse coding based classification, according to an embodiment.

FIGS. 2A and 2B illustrate a block diagram of an example of a workflow in a system for sparse coding based classification, according to an embodiment.

FIGS. 3A and 3B illustrate a block diagram of an example of a workflow in a system to create a dataset for sparse coding based classification, according to an embodiment.

FIG. 4 illustrates a block diagram of an example of a system using a network edge neuromorphic processor to sparse code sensor data, according to an embodiment.

FIG. 5 illustrates an example of a spiking neural network to implement a sparse encoder, according to an embodiment.

FIG. 6 illustrates an example of a sensor network communicating sparse encoded sensor data, according to an embodiment.

FIG. 7 illustrates a block diagram of an example of a system using down sampled sensor data to sparse code sensor data and classify the result, according to an embodiment.

FIG. 8 illustrates a block diagram of an example of a system using sparse codes to create super-resolution sensor data, according to an embodiment.

FIG. 9 illustrates a flow diagram of an example of a method for sparse coding based classification, according to an embodiment.

FIG. 10 is a block diagram illustrating an example of a machine upon which one or more embodiments may be implemented.

### DETAILED DESCRIPTION

parse coding is a technique for representing an input signal as a linear combination of a small number of features. A set of these features (e.g., atoms, primitives, entries, etc.) is called a dictionary. An analogue may be a language where the input signal is a string of words and the features are characters in an alphabet. Another analogue may be image compression in which a raster image is the input signal and the features are Discrete Cosine Transform (DCT) basis functions. These examples, however, operate on a fixed set of primitives without regard to the data being encoded. In contrast, sparse coding generally uses a dictionary computed directly from training data for a task, such as representing a heart rate, a vehicle, animal vocalizations, etc. Dictionary training and sparse coding have been demonstrated to be effective for a variety of artificial intelligence applications, including computer vision, speech recognition, and robotics.

Dictionary training extracts features from data by identifying recurring patterns, some of which are not directly observable in the data (e.g., latent patterns). A variety of mathematical formulations and associated algorithms exist to train dictionaries. For example, k-means clustering and K-SVD seek to find the best possible dictionary D∈ [symbol] ^{m×d} that solves:

$${min}_{D , Z} \{ {‖ Y - DZ ‖}_{F}^{2} \} subject to ∀ i , {‖ {z}_{i} ‖}_{0} \leq k$$

where |⋅| F is the Frobenius norm, Y∈ [symbol] ^{m×n} is the training data set—each column yᵢ in Y is a training sample, and Z is the sparse representation in D of Y—each zᵢ has at most k non-zero elements). D is generally over complete (e.g., m<<d) and m or d may be large.

Given a trained dictionary \hat{D} and new input data y′, sparse coding finds a coefficient vector z (e.g., the sparse code) that represents datum as a weighted combination of a small number of atoms in the dictionary. The sparse coding may be carried in several ways. For example, L0-regularization involves:

$${min}_{z} \{ {‖ {y}^{′} - \hat{D} z ‖}_{2}^{2} + λ {‖ z ‖}_{0} \}$$

Here, the L0 penalty term limits the number of atoms used to encode the input. This limitation may be used to enforce a sparsity constraint on z. However, L0-regularization generally produces non-deterministic polynomial-time (NP) hard optimization problems. Another formulation that may be used is a related convex formulation, such as L1-regularization (also known as the least absolute shrinkage and selection operator (LASSO)):

$${min}_{z} \{ {‖ {y}^{′} - \hat{D} z ‖}_{2}^{2} + λ {‖ z ‖}_{1} \}$$

L1 formulations may be readily solved with strong error and information loss guarantees. L1 formulations also may use a large suite of traditional convex optimization solvers, greedy approximation techniques; and fast domain-specific algorithms on computing sparse codes.

A dictionary of a target (e.g., a specific person's face, moisture sensing, seismic activity, etc.) is trained by collecting training data of the target. The training data is divided into patches (e.g., for a video, each video frame may be split into strided, overlapping patches). A training set Y is formed by treating each patch as a training sample yᵢ and train a dictionary \hat{D} as described above.

Sparse coded data may be used in several ways to facilitate classification or regression generally, as well as in deployed sensor networks, which is becoming more common with Internet of Things (IoT) deployments. For example, classification and regression may be performed, at least in part, on the feature space of sparse coded data rather than the raw data itself. This may provide a more efficient implementation, correct for sensor errors, or otherwise tolerate a higher level of noise in the data. In an example, efficient sparse coding may be carried out in resource constrained devices to produce feature space representations of raw sensor data that is then communicated to other entities (e.g., cloud services, servers, etc.) for classification. Sparse code representations may provide additional avenues to optimize transmission efficiency as well as processing efficiency at the network edge.

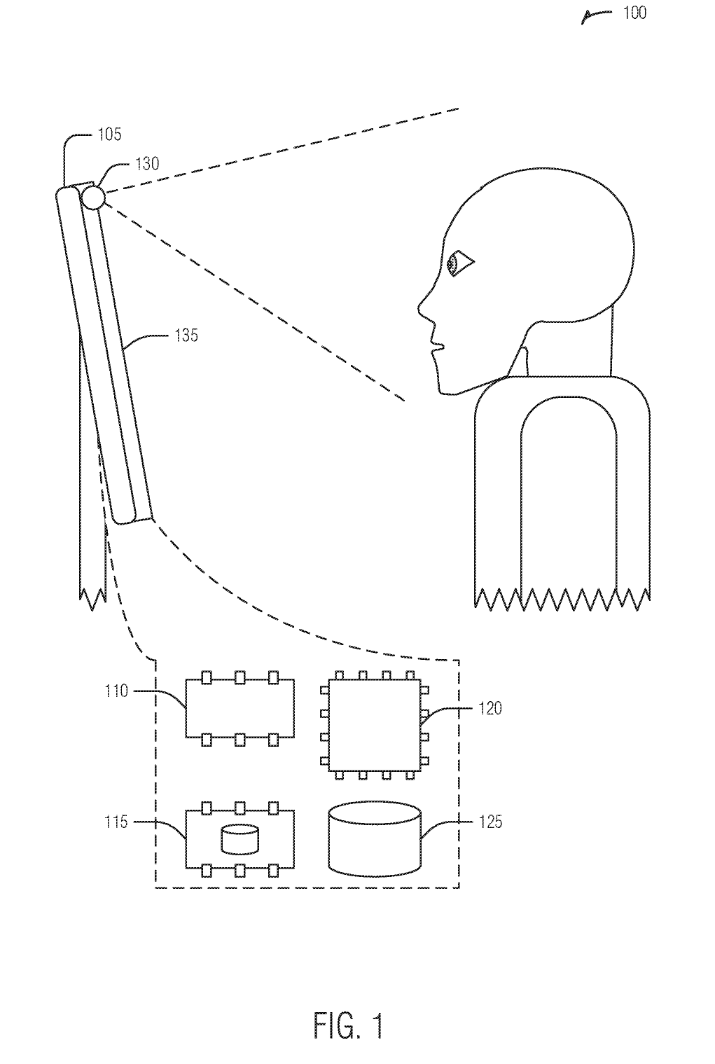

FIG. 1 is a block diagram of an example of an environment 100 including a system 105 for sparse coding based classification, according to an embodiment. The system 105 may include processing circuitry 120, and media 125 to store instructions or data for the processing circuitry 120. The system 105 may also include an encoder 110 or dataset 115. These components are implemented in electronic hardware, such as that described below (e.g., circuitry).

The processing circuitry 120 is configured to obtain (e.g., retrieve or receive) a sample of a first type of data. For example, the sample may be buffered in the media 125 and requested by the processing circuitry 120. Once the sample for the first type of data is acquired, the processing circuitry 120 is arranged to encode the sample to create a sparse coded sample. In an example, the processing circuitry 120 may direct the encoder 110 to perform the encoding. The result of the encoding, the sparse coded sample, is a representation of the sample including references to a sparse coded dictionary. To re-create the sample from the sparse coded sample, the references (e.g., coefficients) to the dictionary are used to selectively recombine elements from the dictionary.

In an example, the sparse coded sample includes a sparse code corresponding to patches of the sample. Patches are a subdivision of the sample. For example, a picture may be divided into non-overlapping quadrants, each of which is a patch. The sparse coded sample would then include a sparse code for each patch (here four sparse codes). In an example, a patch of the patches is less than the sample. Thus, there are more than one patch. In an example, a first patch and a second patch overlap a same portion of the first sample without being equal to each other. In this example, some portion of the two patches cover the same data from the sample. Overlapping the patches may address aliasing issues, or other boundary conditions. In an example, the sparse coded sample that includes multiple sparse codes may also have a sparsity constraint. The sparsity constraint limits the number of references to the dictionary. This may have a dual benefit of reducing the size of the sparse code as well as to combat over fitting.

In an example, to encode the sample to create the sparse coded sample, the processing circuitry 120, or the encoder 110, is arranged to use Orthogonal Matching Pursuit (OMP) to create sparse codes for the sparse coded sample. In an example, Least Angle Regression (LARS) is used to create sparse codes for the sparse coded sample. These analytical techniques may be replaced, or supplemented with using a spiking neural network (SNN) to create sparse codes for the sparse coded sample. A SNN is a type of artificial neural network in which signal time of arrival influences the behavior of the network. Thus, it is not only relevant that a signal (e.g., spike) arrived at a dendrite of a neuron, but also when with relation to other arriving spikes, as well as axon (e.g., output) spikes produced by the neuron. Spike timing dependent plasticity (STDP) describes how an SNN may be configured for unsupervised recognition of even complex patterns.

In an example, the SNN is implemented in neuromorphic hardware. Neuromorphic hardware is a new class of processing devices, or collections of processing devices, that more closely mimic the structure of animal neurons. Generally, neuromorphic processors avoid complex instructions for a relatively simple add-and-test processing whereby incoming spikes are weighted and accumulated to determine whether an output spike will issue. Instead of complex processing, this hardware attempts to replicate the extremely numerous connections present in complex natural brains, often providing different weightings (e.g., modifiers to the “add” portion of add-and-test) depending on where a spike originates.

In an example, the SNN performs a Locally Competitive Algorithm (LCA) to solve a least absolute shrinkage and selection operator (LASSO) to create the sparse codes for the sparse code dictionary. In an example, the SNN includes a neuron for each entry in the dictionary arranged in a single fully connected layer, each neuron including an input, an output, and inhibitory outputs connected to other neurons. Inhibitory connections allow a SNN using STDP to recognize a greater number of patterns without supervision. STDP results in convergence upon patterns because spike stimuli that coincide at a neuron will strengthen that neuron's response. By send a spike to a neighboring neuron as an inhibitory spike (e.g., reducing the chance of, or completely inhibiting, a spike in the recipient), the neuron that first converges on a pattern prevents the other neurons from converging on the same pattern. Thus, these other neurons will converge on other patterns present in the stimuli.

The processing circuitry 120 is arranged to search the dataset 115 using the sparse coded sample to locate a segment set of a second type of data. Thus, the sparse coded sample is the key, or search term, in the dataset 115, for the segment set of the second type of data. In an example, the dataset 115 has an upper bound on items contained therein. This is often expressed as a sparsity constraint. Again, maintaining sparsity is useful to prevent over fitting and to reducing processing or storage resources when using the dataset 115.

In an example, to search the dataset 115 using the sparse coded sample to locate the segment set, the processing circuitry 120 is arranged to compare the sparse coded sample to sparse codes in the dataset to establish distances between the sparse coded sample and the sparse codes. Here, the processing circuitry 120 is locating sparse codes in the dataset 115 that are close to the sparse coded sample, and quantifying just how close they are. The processing circuitry 120 is arranged to filter the sparse codes by the distances to identify a nearest neighbor set. Thus, a set of the most applicable (e.g., nearest neighbors) sparse codes from the dataset 115 are identified for the sparse coded sample. In an example, the size of the nearest neighbor set has an upper bound (e.g., there is a maximum cardinality imposed on the nearest neighbor set). A variety of distance techniques may be used to measure the distances between the sparse coded sample and the dataset 115 sparse codes. For example, an L1 norm may be used due to its quick and efficient implementation.

In an example, the nearest neighbor set includes segments of the first type of data and corresponding segments of the second type of data. Here, the first type of data is used as an index for the second type of data. Thus, in an example, searching the dataset using the sparse coded sample to locate the segment set includes comparing a segment of the sample to segments of the first type of data in the nearest neighbor set to identify a closest match and returning a second type of data segment from the nearest neighbor set that corresponds to the closest match. Thus, after the nearest neighbor set is produced, a search for a single first type of data representative that matches the sparse coded sample is performed to find the corresponding second type of data. In an example, finding the closest match includes using an L2 norm to determine distances between the segment of the sample and the segments of the first type of data. Here, a member of the nearest neighbor set with a first type of data segment having the shortest distance is selected. The L2 norm may be more computationally expensive than an L1 norm, however, it often provides greater accuracy. Thus, the use of the L1 norm to reduce the elements of the dataset 115 upon which the L2 norm is performed provides a good balance of accuracy and efficiency in locating a segment of the second type of data that most closely corresponds to the sparse coded sample in the first type of data.

In an example, the first type of data is produced by a first sensor (e.g., camera 130) and the second type of data is produced by a second sensor. In an example, the first sensor is a camera that produces a two-dimensional image. In an example, the two-dimensional image is a grayscale image. In an example, the second sensor is a depth camera that produces a depth image. Thus, in these examples, the system 100 performs lookup of a depth segment based on a grayscale image. Other types of data may be correlated using sparse codes as described above. For example, the first sensor may be a heart rate monitor (e.g., a photo plethysmography (PPG) sensor) and the second sensor may be an electrocardiography (ECG) sensor. Other combinations of sensors, and thus the first type of data and the second type of data, may be employed.

In an example, the first sensor is deployed in a first device. Here, obtaining the sample of a first type of data and encoding the sample to create a sparse coded sample are performed at the first device and searching the dataset 115 using the sparse coded sample to locate a segment set of a second type of data and creating an instance of the second type of data using the segment set are created at a second device. In an example, the processing circuitry 120 is arranged to transmit the sparse coded sample from the first device to the second device. Splitting the sparse coding and the dataset 115 searching allows for a hybrid edge and cloud solution whereby the edge sensor (e.g., camera 130) performs and transmits the sparse coded sample to a remote device (e.g., cloud service) to perform search for the second type of data segment. Such a division of labor allows for simpler devices to be deployed at the edge while conserving networking resources via the use of sparse codes in the transmission.

In an example, the processing circuitry 120 is arranged to obtain a classification target and select a sparse code dictionary from several dictionaries based on the classification target. Thus, if the classification target is for a certain make of automobile, a sparse code dictionary specific to that automobile is selected. In an example, where the sparse coding and data type matching are performed on different devices, the second device may select the sparse code dictionary based on the classification and transmit the sparse code dictionary to the first device. Here, the second device is remote from the first device. In an example, transmitting the sparse code dictionary to the first device includes transmitting a pre-computed Gram matrix for the sparse code dictionary to the first device. The Gram matrix computation may be computationally expensive but also may be performed once for a given dictionary. Thus, providing the pre-computed Gram matrix for a given dictionary relieves the first device (e.g., an edge device) from having to perform the computation.

The processing circuitry 120 is arranged to create an instance of the second type of data using the segment set. Thus, original data is captured by a first sensor 130. A sparse coding of the original data is created (e.g., using encoder 110 and dataset 115). The sparse coding is then used to locate a correlation between the original data and the second data type. This is accomplished by establishing a correlation between the first type of data and the second type of data on segments, storing them, and then using the sparse coded sample to locate segments of the first type of data in the dataset 115. Once the segments of the second type of data are located, they are reconstructed into sensor output based on the sparse coding of the original data. Thus, an instance of the second type of data is created. Using this technique, a dictionary may be created to correlate grayscale images to depth images. Later, a grayscale image may be captured and converted into a depth image using the technique above. This same technique may be performed on any two types of sensor data for which the dictionary may be created. The newly created second type of data may be presented to the user, for example, via the display 135.

To create the dictionary, the device 105, or another device, is arranged to create a first patch set for first type of data training data and a second patch set for second type of data training data. Here, each patch in the second patch set corresponds to a patch in the first patch set. The correlation is a special one. Thus, if a first quadrant of an image is the space, corresponding patches in the first patch set and the second patch set represent the first quadrant for each sensor. Sparse codes are created for members of the first patch set. Then, the dataset 115 is created with a record for each member of the first patch set that includes a corresponding sparse code and member from the second patch set. In an example, sparse code dictionary is trained from the first type of data training data. In an example, training the sparse code dictionary from the first type of data training data includes using K-SVD to create the dictionary. In an example, entries from the dictionary are removed when a frequency of use in sparse coding falls below a threshold. Dictionary pruning permits accurate representations of the data using the dictionary while also reducing the size of the dictionary and the search spaces for the nearest neighbor set and the closest match described above.

The sparse coding techniques also permit many advantages for analyzing or transmitting data. For example, an original sample may be downsized to produce the sample. Often, simply scaling the image down reduces computational complexity (e.g., fewer pixels to examine) without a significant reduction in accuracy. In an example, the down sampling is bounded by an entropic analysis of the first type of data. Again, such a technique may help to reduce edge computations, allowing for the deployment of simpler devices at the edge.

Below are additional details and examples for a variety of techniques described above. For example, Sparse Coding Nearest Neighbor (SCNN), is a general technique for solving classification and regression problems on sensor systems, such as in mobile applications or IoT devices. For clarity, the examples below address the classification or regression problem of recovering 3D depth information from only a 2D grayscale image. This problem is challenging because a grayscale-to-depth mapping may be both many-to-one as well as nonlinear (e.g., because of wide variation in lighting conditions).

SCNN first transforms the input image into a sparse feature representation (sparse code) in a learned feature space and then associates this sparse code with known depth information of its nearest neighbors in the feature space (e.g., the result of sparse coding). This technique has at least four advantages over directly mapping the grayscale data to the depth data: range may be extended and depth image quality may be improved; the technique generalizes well to unseen inputs; low-resolution or noisy inputs well tolerated; and the computation cost is low, making it suitable for mobile or IoT platforms.

As noted above, to solve the depth recovery problem, SCNN associates an input 2D grayscale image patch with a similar reference patch for which depth information is known. To accomplish this, SCNN identifies a candidate set of reference patches that are similar to the input patch via a nearest neighbor search. The known depth information associated with the closest match among these nearest neighbors is then deemed to be the recovered depth. A conventional approach may perform the nearest neighbor search in pixel space, but since this domain is dense, the operations are costly; the operations may not generalize well to unseen inputs; and the operations are not as robust against noise or variations in lighting. SCNN achieves speed and accuracy over the conventional approach by performing the nearest neighbor search in a domain of sparse representations based on a learned dictionary.

Generally, SCNN operates in two phases. In the offline training phase, a 3D camera is used to capture a set of depth images of a scene of interest. These images are used to generate a patch database which associates the 2D grayscale patches comprising the images with their corresponding depth patches. The offline training continues by employing an unsupervised dictionary learning technique to learn features from the 2D grayscale patches. Thus, the dictionary includes a sparse coding of the grayscale patches along with corresponding depth patches.

In the subsequent online depth recovery stage, given an input 2D grayscale patch with unknown depth information, the learned dictionary is used to encode each patch of the input image into the learned feature space via sparse coding. That is, each patch is represented by a linear combination of just a few learned features out of the entire dictionary (hence the term “sparse code”). The nearest neighbor search is performed in the sparse, rather than pixel, domain by comparing the input patch's sparse code against the sparse code of the grayscale patches in the patch database. Conducting the nearest neighbor search in the sparse domain increases the speed of the search because it employs, for example, simple L1-distance calculations on sparse vectors. In addition, sparse coding not only provides robustness to noise as the learned features are denoised, but also allows better generalization to new, unseen input patches.

In the depth recovery problem, SCNN is given an input grayscale patch and finds its closest match among a database of grayscale patches for which depth information is known. SCNN may be initialized offline once and then used any number of times for online recovery of depth information from subsequent 2D image inputs from similar scenes. The offline phase involves creating or training the sparse code dictionary. The online phase involves using that dictionary for SCNN. For the offline phase, a labeled training set T comprised of tuples <xᵢ, yᵢ>, where yᵢ=f(xᵢ) is the label of xᵢ is obtained. A dictionary D is trained from the set of xᵢ, using a dictionary learning method such as K-SVD. Each entry in the resulting dictionary is a feature extracted from X. The sparse codes zᵢ in D for all xᵢ may then be computed. These tuples <xᵢ, zᵢ, yᵢ> may now be stored in a database B.

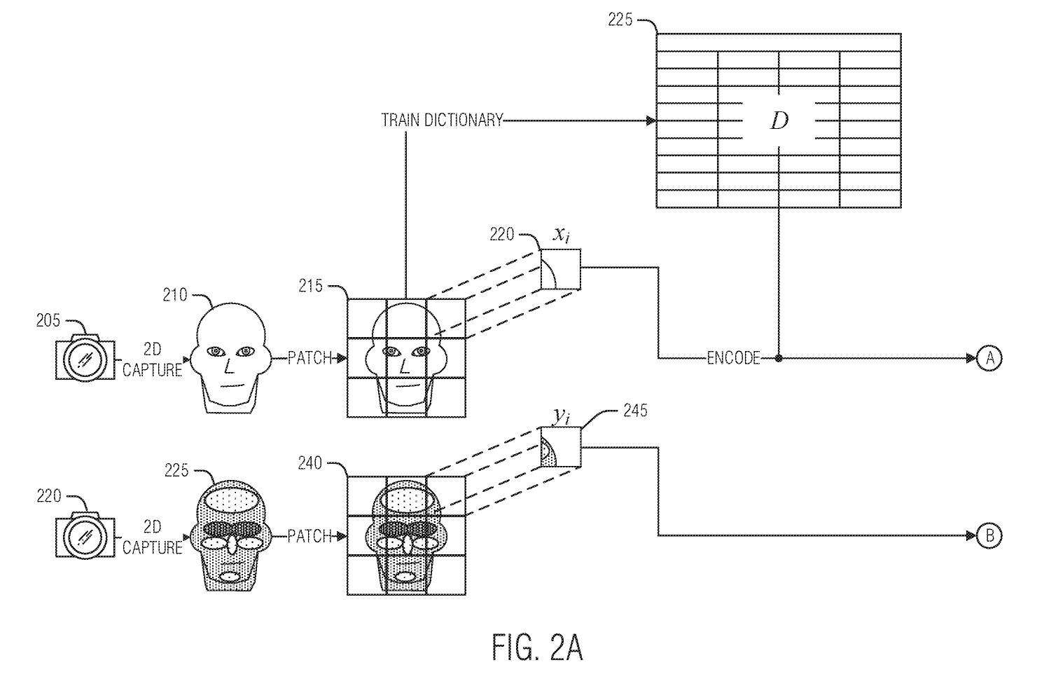

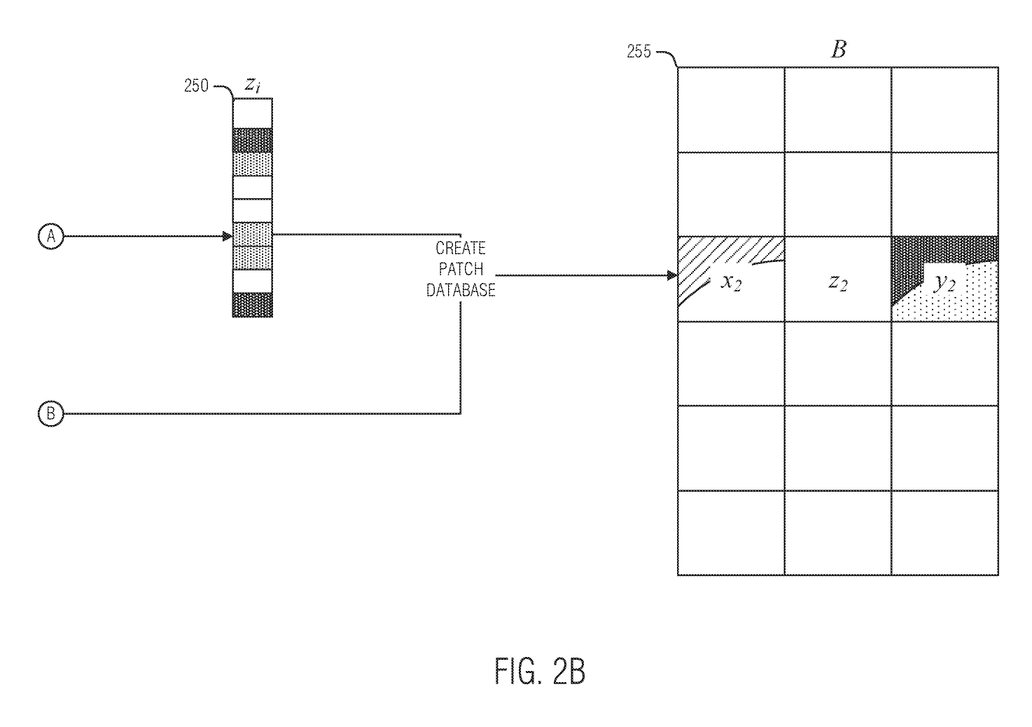

FIGS. 2A and 2B illustrate a block diagram of an example of a workflow in a system for sparse coding based classification, according to an embodiment. The workflow is an example of the offline phase. A data collection operation may acquire a set of images with both color information 210 (e.g., Red-Green-Blue (RGB)) and depth information 225. In an example, the information is combined into a single format image (e.g., RGB-D images). The color information 210 may be obtained from a visual light sensitive camera 205 and the depth information 225 from a depth camera 220. In an example, a single device captures both the color information 210 and the depth information 225. In an example, the color information 210 may be converted to grayscale.

Patches 215 and 240 may be extracted from these images to form tuples of grayscale patches xᵢ 220 and corresponding depth patches yᵢ 245, which are stored in training set T. The patch size and the overlap between consecutive patches are configurable based on dictionary learning details (e.g., what type of data is being processed among other things). A dictionary D 225 is learned from the grayscale patches xᵢ 220 in T using K-SVD, for example. The learned dictionary D 225 may be used to calculate the sparse code zᵢ 250 for each grayscale patch xᵢ 220 in T.

A database B 255 is created with the sparse codes 250 obtained above. An entry in B 255 is a tuple <xᵢ, zᵢ, yᵢ>, where xᵢ 220 is a grayscale patch, zᵢ 230 is its corresponding sparse code, and yᵢ 245 is its corresponding depth patch. In an example, the grayscale patch 220 may be omitted from B 255, such that an entry is the tuple <zᵢ, yᵢ>.

After the offline phase is complete, the database B 255 is ready to be used in the online phase. In the online phase, a new, unseen test instance (e.g., first type of data) is presented. The online phase will find a corresponding second type of data for this instance by converting the instance into a sparse coded sample (with D 225), and locating the second type of data in B 255 with the corresponding sparse coded sample. The search for the second type of data uses the K_{N} nearest neighbors of in B 255 by comparing the L1 distance to the sparse codes in each tuple of B 255. Once the nearest neighbor set is determined, the second type of data (e.g., a label for the first type of data) is found within the K_{N} nearest neighbors. For instance, we may choose the closest neighbor's label or the majority label present in the K_{N} nearest neighbors, or take an average over all labels—the specific technique for deriving the second type of data being specific to the problem domain.

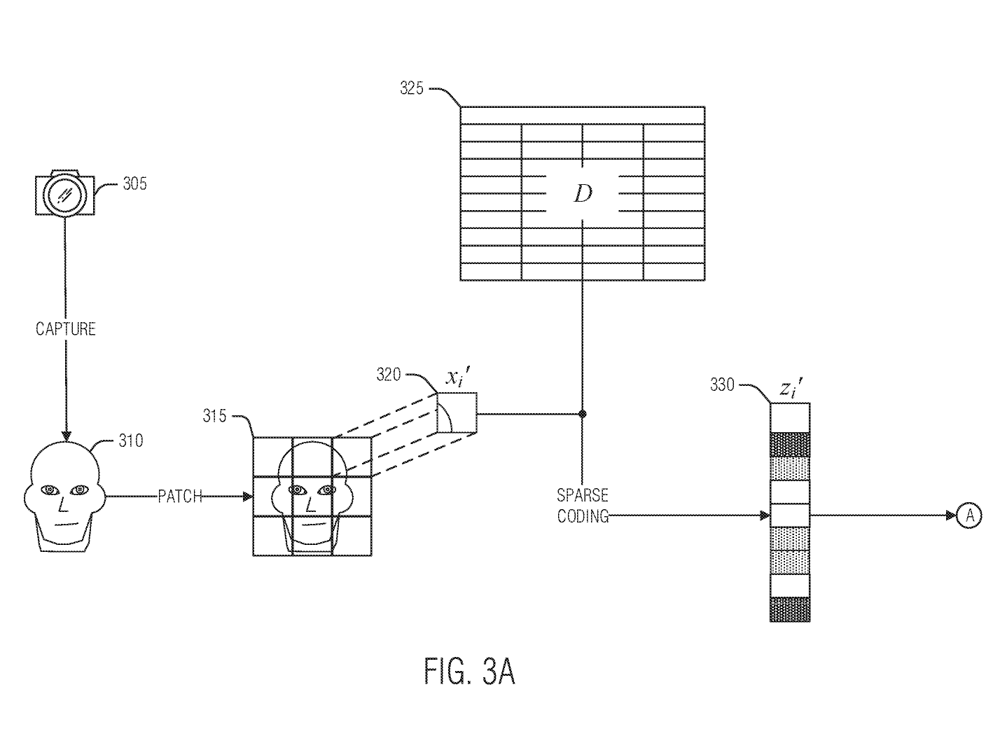

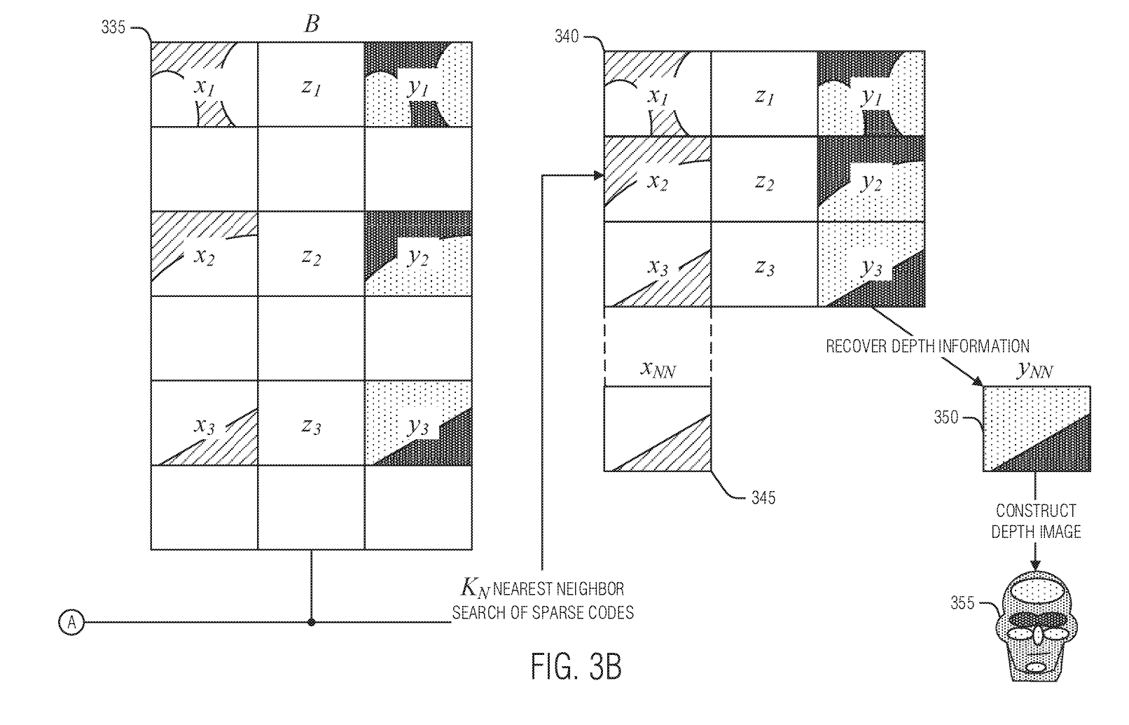

FIGS. 3A and 3B illustrate a block diagram of an example of a workflow in a system to create a dataset for sparse coding based classification, according to an embodiment. The workflow is an example of the online phase.

The dictionary D 325 and the database B 335 were previously created during an offline phase. The input is a grayscale image 310 captured with a conventional 2D camera 305. The input image 310 is converted into a set of patches 315 in the same manner as the training set in the offline phase. For each patch xᵢ′ 320, the sparse code zᵢ′ 330 is calculated from D 325 using, for example, OMP, LARS, or other technique.

After the sparse codes 330 are computed, a search for K_{N} Nearest Neighbors is performed. Here, for each sparse code zᵢ′ 330, the sparse codes zᵢ in the database B 335 for the K_{N} nearest neighbors 340, as defined by the L1 distance between zᵢ′ and zᵢ. Once the K_{N} nearest neighbors 340 are located with each input grayscale patch xᵢ′ 320, for each xᵢ′ 320, a closest (e.g., in the L2 sense) matching patch x_{NN} 345 is located among that set 340 in grayscale space. The depth patch y_{NN} 350 corresponding to x_{NN} 345 is taken as the recovered depth patch. Once the depth patches are recovered, the depth patches are concatenated appropriately (e.g., in accordance with the technique used to create them originally including overlapping portions, etc.) to produce the final output depth image 355.

Several parameters may be adjusted to produce different performance profiles for SCNN. Often, these parameters are available for in a device as well as in software. For example, on resource constrained mobile or IoT platforms, it may be advantageous to tune the parameters to favor lower computation cost or storage requirement. A parameter that may be adjusted is patch size. Because SCNN searches for a patch in the database that is most similar to the input patch, patch size is large enough to provide meaningful differentiation between patches in the database. However, patch size should not be so large that the learned features in the dictionary over fit to the training set. Within these boundaries, choosing patch size represents a trade-off between recovery accuracy and generalization to unseen inputs.

Another parameter that may be adjusted is patch overlap. Increasing the overlap between patches may improve the resultant second type of data (e.g., a recovered depth image). Because each patch is independently recovered, the averaging procedure effectively washes away noise and patching artifacts (e.g., blockiness). Generally, the more overlap between patches, the more noise is removed. However, increasing the overlap also increases the number of patches and thus the overall computations. As a result, there is a trade-off between recovery accuracy and computation speed/cost in patch size selection.

Another parameter that may be adjusted is the number of nearest neighbors (e.g., cardinality of this set) K_{N}. A relatively large K_{N} increases the chance that a closer match to the input patch will be found among the patches in the nearest neighbors set. However, increasing K_{N} directly impacts recovery speed, since the L2 distance is computed between the input patch and every patch in nearest neighbor set. Therefore, the choice of K_{N} results in a tradeoff between recovery accuracy and computation speed/cost. Experimentally, we find that even relatively small values of K_{N} achieve acceptable results.

Another parameter that may be adjusted is the encoding sparsity (K_{S}). This parameter determines the sparsity (e.g., the number of non-zero coefficients) of the sparse codes. If K_{S} is set too low (e.g., there are very few non-zero coefficients), the resulting sparse codes may under fit the data (e.g., they may be too generalized). Thus, the sparse feature space may not be amenable for identifying the nearest neighbors during recovery. Conversely, if K_{S} is set too high (e.g., there are many non-zero coefficients), the sparse codes may over fit to the data and not generalize well, again resulting in a poor selection of the nearest neighbors. K_{S} may be selected based on a simple grid-search procedure, where the goal is to minimize some error metric, such as L2 error between the actual and recovered depth image.

Another parameter that may be adjusted is the dictionary size (N_{D}). This parameter determines the number of features learned during dictionary training. Increasing the dictionary size generally improves recovery by producing more accurate sparse codes that are more differentiated, resulting in higher quality nearest neighbors being selected. However, larger dictionaries may involve longer encoding times, resulting in slower depth recovery and larger storage use. Therefore, dictionary size represents a trade-off between recovery accuracy and computation speed or cost as well as storage cost.

Another parameter that may be adjusted is the training set size (N_{T}). A larger training set may improve recovery accuracy. However, since the training set is used as the depth patch database (e.g., patches from the second type of data in the training set are stored directly in the database), a larger set may increase the nearest neighbor search time.

SCNN has at least four characteristics that make it an attractive solution to classification and regression problems. First, with respect to reconstructing depth images from grayscale images, SCNN extends the range and improves the depth image quality. In practical applications, such as object detection and gesture recognition, the target object may be located at arbitrary distances from the camera. To address discrepancies between the canonical distance and the arbitrary distance of the target object to the camera, SCNN may detect, crop, or resize the target object to its canonical size. In this way, SCNN may accurately recover the depth information when the target is at other distances.

Second, SCNN generalizes well to unseen inputs. For a given object class (e.g., a hand), SCNN may generalize well to previously unseen inputs.

Third, SCNN tolerates down sampling or noise in the input. If the training data used to learn the feature dictionary is high quality, SCNN may effectively denoise inputs by expressing noisy or down sampled inputs in terms of the high-quality features in the dictionary. Because a down sampled image may still be used to recover depth information accurately, inexpensive, low-resolution 2D image sensors may be used to perform depth recovery.

Fourth, SCNN exhibits a significantly reduced computation cost over traditional techniques. Because SCNN operates on sparse vectors rather than dense pixel information, the computational cost is significantly reduced. In the depth recovery example, performing the nearest neighbor search in the dense pixel space would be cost prohibitive. This is borne out in the following complexity analysis. Given input patch size M, dictionary size N_{D}, encoding sparsity K_{S}, K_{N} nearest neighbor, and patch database size N_{T}, the online computational complexity of SCNN includes the following components: (1) computing the sparse code of the input patch at cost MN_{D}K_{S}, (2) identifying the K_{N} nearest neighbors from the patch database in the sparse domain at cost N_{T}K_{S}, and (3) identifying the closest match among the K_{N} nearest neighbors at cost K_{N}M. Thus, the total cost for SCNN is:

MN_{D}K_{S}+N_{T}K_{S}+K_{N}M=M(N_{D}K_{S}+K_{N})+N_{T}K_{S}

In contrast, the nearest neighbor search in pixel space has a total complexity of MN_{T}. Thus, the computational complexity gain of SCNN over pixel-space nearest neighbor search is:

$$\frac{{MN}_{T}}{M ( {N}_{D} {K}_{S} + {K}_{N} ) + {N}_{T} {K}_{S}}$$

Generally, the lower bound of this gain is used. Assuming that N_{D} \sqrt{N_{T}}, K_{N}≤\sqrt{N_{T}}, and K_{S} is small (e.g., K_{S}<<N_{D}, the lower bound gain is

$$\frac{{MN}_{T}}{M ( \sqrt{{N}_{T}} {K}_{S} + \sqrt{{N}_{T}} ) + {N}_{T} {K}_{S}} = \frac{M \sqrt{{N}_{T}}}{M ( {K}_{S} + 1 ) + \sqrt{{N}_{T}} {K}_{S}}$$

For example, if M=1,000 and N_{T}=1,000,000, and K_{S}=10, SCNN exhibits at least a 47-fold complexity gain. In other words, SCNN may speed up the recovery of depth information by an order of magnitude.

SCNN is a technique to create a second type of data from a first type of data using a feature domain nearest neighbor search. Sparse codes may be used more generally in the IoT domain, however. For example, a sensor may sparse code its measurements and then send the sparse codes to another device for interpretation or other processing. Newer hardware designs, such as neuromorphic processors, may allow the sparse coding of sensor data at greatly reduced time and power than current processors. Thus, neuromorphic processors and sparse coding sensor data provide an effective IoT device combination.

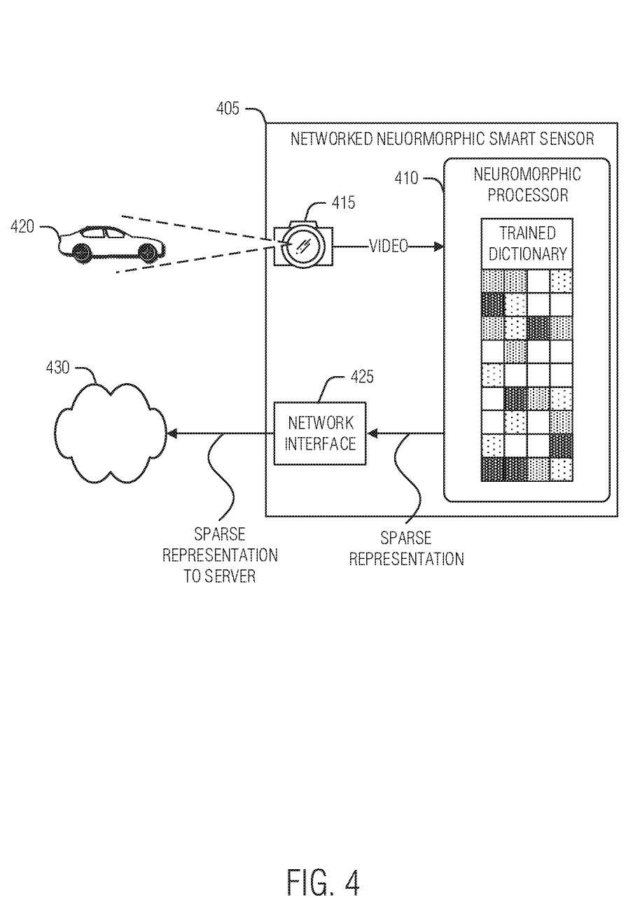

FIG. 4 illustrates a block diagram of an example of a system using a network edge neuromorphic processor 410 to sparse code sensor data, according to an embodiment. In overview, the system is a content-aware sensor network system that performs machine learning at the edge sensor by extracting learned features from the sensor's signals, and transmits a digest of application-relevant features to a server for further processing. Feature extraction is performed via sparse coding on the neurmorphic processor 210. Generally, a neuromorphic processor is a reconfigurable network of biologically-inspired spiking neurons implemented in silicon.

Previous distributed sensing applications have generally relied on computationally complex machine learning (ML) and computer vision (CV) algorithms. Thus, these previous systems use significant computing resources, both in terms of speed and power. Since speed and power are not usually available at an edge sensor, existing sensor networks generally stream raw sensor data from the network edge to a centralized server for processing. Such an architecture is content-unaware and blindly transmits all data back to the server. This often leaves the server to determine what is relevant and what is irrelevant to the application. Not only is this an inefficient use of uplink network bandwidth (which is typically constrained in may IoT deployments), it also creates a traffic fan-in bottleneck at the server.

The system of FIG. 4 performs feature extraction at the network edge (e.g., device 405), which not only reduces network traffic, but also supports richer application-level objectives, since sensor data is already expressed in terms of features of interest. The example illustrated is a distributed camera system, in which a network of mobile or fixed cameras coordinate to sense over a physical area that, perhaps, cannot be covered by a single sensor. Applications may include object recognition (e.g., finding an AMBER alert license plate in a city), anomaly detection (e.g., intrusion in a crowded area), or tracking/localization (e.g., autonomous robots in a warehouse). Thus, the subject 420 may be captured by a sensor 415 of the device 405. The neuromorphic processor 410 uses a previously trained dictionary to produce a sparse representation of the sensor data of the subject 420. The network interface 425 is then used to transmit the sparse coded information to a remote device 430. As explained below, the embedded trained dictionary in the neuromorphic processor may not be a traditional table or database, but rather a configuration for the neuromorphic processor, containing synaptic weights, neuron connections, etc., that represents the trained dictionary.

For example, a scenario where a network of deployed smart cameras 405 is tasked to search for a specific target object 420 within its monitored area is presented. From training videos, a dictionary of features specific to the target object 420 is learned, for example, using STDP in the cloud 430. This dictionary may be transmitted (e.g., broadcast) to each smart camera 45, where it is used to reconfiguring each neuomorphic processor's spiking neuronal network (SNN) to solve a sparse coding problem specific to the dictionary. The neuromorphic processor 410 may then sparse code (e.g., encode) the video stream emitted by each sensor's camera 415 into a stream of feature vectors (aka sparse representations in the dictionary's domain) by feeding each frame into the configured SNN. Then, from each sensor 405, the sparse representations may be sent to a server 430 that performs classification on the incoming sparse representations to determine whether the target object was detected.

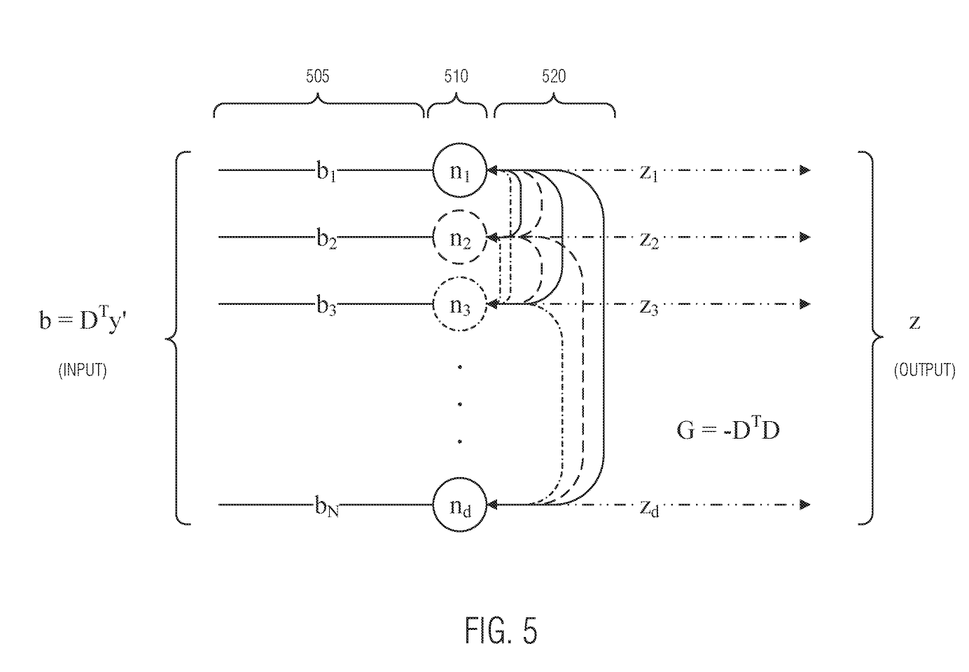

The technique involves creating a sparse code dictionary as discussed above. This dictionary will then be used at the sensor 405 to sparse code the subject 420. For example, given a new input video frame, we first split the frame into patches as before, and sparse code each patch yₚ′ independently. An SNN organized to perform the sparse coding is described below with respect to FIG. 5. Depending on the application, further manipulations of the resulting sparse code z may be performed. For example, if a search for the “nearest neighbor” atom is performed, the index of the largest coefficient of z may be used.

In an example, a distributed design is employed. Here, one or more nodes in the sensor network is a “networked neuromorphic smart sensor” 405. These nodes include a sensor (e.g., camera) camera 415, a neuromorphic processor 410, and a network interface 425 and is connected over a WAN/LAN to a central server 430. In an example, the system is initialized for a particular application by transmission and installation of trained dictionaries onto the sensor 405 over the network. Depending on the application's requirements, each sensor 405 may be installed with a different dictionary or the same dictionary.

When the sensor 405 receives a dictionary, the sensor 405 configures its neuromorphic processor's SNN accordingly (e.g., see FIG. 5). The sensor 405 then begins operating. The camera 415 captures pixel intensities—for simplicity, a single color channel is considered, however the extension to multiple channels is straightforward—of each video frame as y′ and passes this to the neuromorphic processor 410, where it is converted into a set of input spike trains: one spike train with spiking rate of bᵢ for each neuron i, as described below. After the SNN receives the input spike trains and converges, the output spiking rate of each neuron is then read out as z, the sparse code. This is then sent via the network interface 425 to the central server 430. Depending on the application objectives, the sparse code z may be further manipulated. For example, an error threshold may set for transmitting z. When an error for z is high, it means that no good sparse linear combination of dictionary atoms could be found to represent the input-likely indicating that the input was not a proper match (e.g., if the dictionary was of a person's face, and the input were of a cat). Thus, an error threshold may set, beyond which the sparse code is not sent but discarded. This is a simple but effective way to filter irrelevant inputs at the network edge.

Another manipulation of z includes reducing the precision of Z. In many applications—e.g., when making relative comparisons of sparse codes across sensors—it may be useful to represent the coefficients with single-precision or double-precision floating point numbers for accuracy. However, experimental evidence suggests that, even for applications that demand high accuracy such as real-time super-resolution, reducing the precision to just 5-bits may be well-tolerated. Furthermore, precision may be adjusted dynamically, as required by the specific application. This may dramatically reduce the network bandwidth utilization. Further, z may be truncated. In the case where the application objective is to find the n nearest neighbor atoms, then only the index of the n largest coefficients in z may be sent. This may dramatically reduce network utilization.

At the server 430, incoming sparse codes may be used directly by the application. For instance, in the example of target object 420 recognition, the sparse codes may be fed directly into a support vector machine (SVM) classifier to determine whether each sensor 405 detected a particular feature set matching that of the target object 420. For example, suppose the smart camera 405 network is deployed in a train station and the application goal is to trigger an alert if anyone in a train station frowns. Each camera 405 sparse codes its input stream and sends the result to the central server 430, where a trained SVM labels the incoming sparse codes as, e.g., “frown” or “smile”. When the SVM outputs a “frown” label, the system alert triggers.

The use of neuromorphic processors to sparse code sensor data for consumption elsewhere has advantages over other approaches, such as local-only, or centralized feature detection. For the example of a completely centralized solution, existing camera networks operate under an architecture where each camera sends a compressed video stream to a central cloud server. There, the streams are generally fed into computationally complex machine learning/computer vision algorithms for object recognition. This approach is largely borne from necessity because it is typically too compute-intensive to perform the object recognition task on the sensor itself. Thus, this approach trades network bandwidth for compute power at the network edge.

The technique described above transmits only when relevant features are detected, thereby reducing network utilization. Sparse coding a video stream with a trained dictionary is itself a form of compression, but unlike traditional video compression methods, the encodings produced are directly useful in object recognition because each sparse representation is a linear combination of relevant features selected from the trained dictionary. When no relevant features are detected, no network traffic is sent. Thus, at the server, in lieu of the typical cascade of computer vision algorithms required to first pre-segment the image/video data and then transform the segments into feature space, our sparse representations may be directly fed into standard classifiers ranging from support vector machines to deep learning networks. In short, our method projects image/video data into the target feature space at the sensor, thereby making the object recognition task at the server much simpler. Thus, the present technique strikes a different balance of resource deployment. First, the SNN is simple-a single layer with as many neurons as features in the dictionary. This transmutes tuning the SNN to tuning the dictionary size, for which there exist principled tools and techniques. Second, a sparse code is outputted as a compact intermediate representation of the input, and therefore provides more application flexibility than a simple label as output. Since these sparse representations are sent to a centralized server, the system has global visibility of the sensor network in the (sparse) feature domain. Thus, more sophisticated queries may be made directly of the sensor network without further CV preprocessing (e.g., which objects with a specific combination of features X, Y, and Z have been seen in this geographic region over the past hour?).

FIG. 5 illustrates an example of a spiking neural network to implement a sparse encoder, according to an embodiment. The LASSO problem (introduced above) may be efficiently solved via the Locally Competitive Algorithm (LCA) on the neuromorphic processor by configuring an SNN according to FIG. 5. For example, given a dictionary D with d atoms, we form a single, fully-connected layer 510 of d neurons, where each neuron represents a unique atom. The connection between neurons i and j is given an inhibitory weight 520 Gᵢⱼ, where G=−D^{T}D—as illustrated, the inhibitory connection has the same dash type as the originating neuron 510. When the SNN takes as input a set of spike trains 505 with spiking rates specified by b=D^{T}y′, the SNN will converge to the sparse coding solution, where the output spiking rates of the neurons correspond to the sparse coefficient vector z.

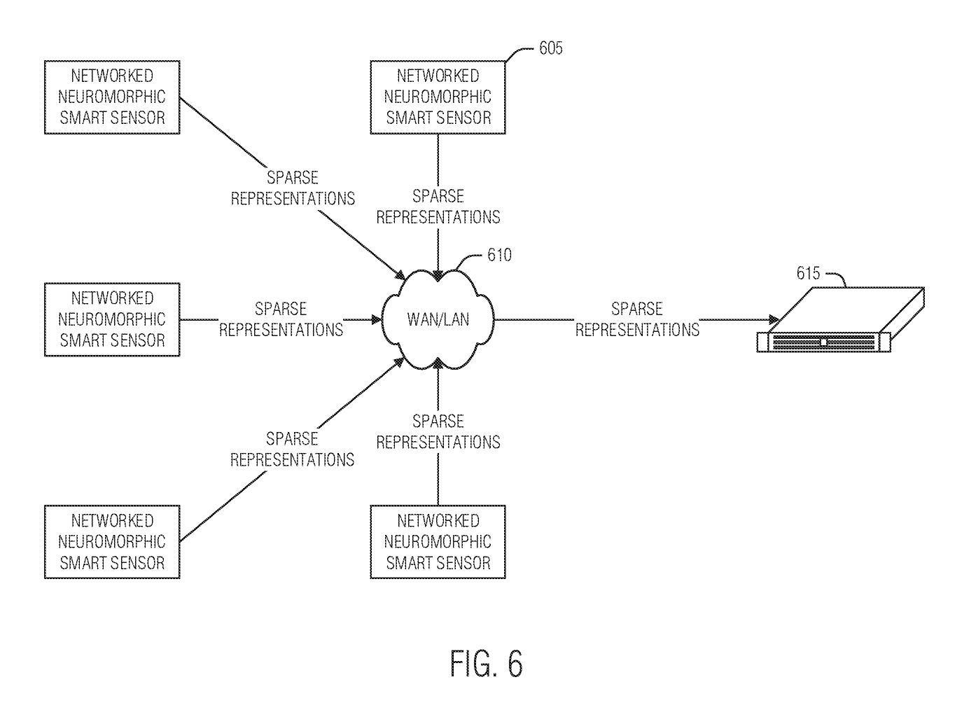

FIG. 6 illustrates an example of a sensor network communicating sparse encoded sensor data, according to an embodiment. Specifically, FIG. 6 illustrates a deployment of neuromorphic-enabled sensors 605, such as that described with respect to FIG. 4, connected to a content consumer 615, such as a server, via a network 610. The use of sparse representations in communicating the sensor data provides a robust and compact technique for sharing the sensor data. Moreover, because the sensor data is communicated in a shared feature space (e.g., as defined by the sparse code dictionary), the server 615 may more easily combine the multitude of sensor 605 data to, for example, complete a data set that any individual sensor is only partially able to capture. Thus, for example, tracking a car across a city where the cameras me the sensors 605 is possible because each camera “speaks the same language” of the feature space.

The SNN smart sensor devices described above provide an exciting step beyond conventional sensing hardware in, for example, IoT sensor deployments. However, even without the neuromorphic hardware above, sparse coding may provide a few advantages to sensor networks. For example, using sparse representations of sensor data (e.g., video streams) instead of the raw sensor data. This technique provides network benefits and relieves many congestion issues in, for example, dense sensor deployments. Further, as noted above, sparse coding the sensor data provides an intrinsic generalization and noise reduction benefit, and also may allow the down sampling of the sensor data to reduce processing at the sensor device.

The examples below generally refer to video from a camera as the sensor and data from the sensor, however, other sensors and data types may be generally substituted without much change. The examples below also generally use the offline dictionary training for sparse coding described above. The following practical sparse coding techniques enable real-time sensor signal feature extraction (e.g., under 33 milliseconds) on resource-constrained edge devices. The techniques also allow for intuitively scaling performance to a target device's processing capabilities, which contrasts with the heuristic methods found in, e.g., deep learning.

The following techniques use a combination of algorithmic choice, implementation, and dictionary pruning, to achieve real-time feature extraction without the need for hardware-specific code optimization. For example, for complex image data, appropriate sparse codes may be extracted despite severe down sampling, enabling deployment across heterogeneous sensor platforms. Down sampling, for example, is based on an information-theoretic interpretation and entropy guidelines to identify a maximum supported down sampling factor. Further, resource constrained devices benefit from pruning a learned feature dictionary to fit the resources constraints of a device.

The sparse coding techniques described here offer benefits over conventional techniques. For example, sparse coding does not require low-level software optimization to be fast. At present, convolutional neural network (CNN) software implementations for mobile devices cannot perform real-time encoding without a significant software optimization effort at the assembly level. Further, sparse coding provides a natural, principled way to deploy onto devices of varying capabilities. Today's existing machine learning applications generally split data processing into multiple phases, performed across edges devices and data centers. For example, deep learning networks such as CNNs, perform feature extraction on mobile devices using CNNs trained offline, e.g., on data center servers. Typically, the training process is computationally intensive and, for large training sets, may take days of training time. Subsequently, it is usually also necessary to reduce the size and complexity of the CNN to fit onto more modest devices such as mobile phones. In practice, this is done using heuristics and trial-and-error.

In a sparse coding regime, training is also done offline. However, sparse coding enables a more natural and principled scaling path for heterogeneous devices, allowing a straightforward trade of storage and computation resources for application accuracy. For example, features may be pruned from the dictionary-decreasing its size-until the encoding time meets a real-time qualification. The pruning may be done based on how often the features are used. For example, the more frequently used a feature is, the more likely it is to be kept, while the more rarely used features are more likely to be discarded. This achieves a graceful degradation in feature extraction accuracy, commensurate to the resources available on the device.

As noted above, one technique to enable real-time sparse coding on resource constrained devices is the choice of encoding algorithm. The raw encoding speed of data into feature vectors is an important consideration for real-time performance. Sparse coding algorithms generally trade-off between speed and accuracy between each other. Thus, those algorithms that are faster typically produce encodings that decode with greater error and vice versa. Selecting an appropriate algorithm includes a consideration of application-level constraints. Many sensor applications (e.g., classification), however, are designed to tolerate error. Accordingly, for these applications, a speedy algorithm may be selected over a more accurate algorithm.

To explain the speed versus accuracy trade-off, consider the relative encoding times of two algorithms that are both greedy approximators: OMP and LARS. While OMP solves for the L0 formulation and LARS the L1 formulation, both operate very similarly by iteratively selecting the dictionary feature that decreases residual error between the current estimated sparse code and the input data. Although these two algorithms appear to have identical algorithmic complexities of 0 (mdk), the constant hidden in this notation significantly changes the actual execution times. Specifically, there are at least two differences that give rise to the disparate runtimes:

(1) OMP greedily adds one selected feature at a time to the coefficient vector to minimize its residual, whereas LARS may add as well as remove atoms from the vector with each iteration; and
(2) OMP updates the coefficient vector by taking the largest possible step in the direction of the least squares direction of the vector's support, whereas LARS must calculate the smallest possible step that introduces a change in the current support. These algorithmic differences contribute to LARS generally producing more accurate sparse codes than OMP, but also using significantly more operations and thus longer runtimes than OMP. Accordingly, for many sensor application, OMP is a more appropriate encoding algorithm.

Another enhancement to a sparse coding enabled sensor systems is precomputation. Sparse coding algorithms often contain quantities that may be precomputed and installed onto devices to reduce encoding time. For example, OMP includes a least squares optimization that use the computation of the Gram matrix D^{T}D of the dictionary D. For dictionaries of even a modest size, this dense matrix-matrix multiplication on resource-constrained devices often takes too long to support real-time applications. However, installing a precomputed Gram matrix along with the dictionary onto the device relieves the devices from processing the Gram matrix itself. When this is possible, the implementation of the specific sparse coding algorithm (e.g., OMP) is accordingly modified to use the precomputed value (e.g., the Gram matrix).

Another enhancement to sparse coding enabled sensor systems is input sizing or down sampling via entropy analysis. Generally, the time used to compute an input's sparse code is directly related to the input's size (e.g., the dimensions of an input image). Thus, down sampling the input reduces the time to process the input, and thus may be used to meet real-time performance. Although down sampling involves removing data points from the input, many applications, such as classification, are robust to down sampled inputs and, wherever down sampling is not well-tolerated, super-resolution techniques may be used to back-fill information lost to down sampling.

When down sampling, a lower bound is establish to ensure that sufficient information content remains to support downstream applications, such as classification or reconstruction. For natural images—an input class of great interest—there is a loose entropic bound that informs the down sampling factor. To establish the entropic bound, each image in the Caltech 256 data set was down sampled to 300×300 to 200×200, 100×100, and 50×50. For each level of down sampling, the entropy of the images was calculated and its distribution plotted. The resultant distribution skewed towards peaks of approximately 7 bits; the down sampling failing to shift the distribution by much. This implies a fundamental bound on the information content in natural images and that even down sampling 36-fold to 50×50 does not reduce the information significantly. It follows that down sampling per these entropy measures does not negatively impact sparse coding. For a specific set of inputs, we may perform the same analysis to find the largest down sampling factor that retains the distribution.

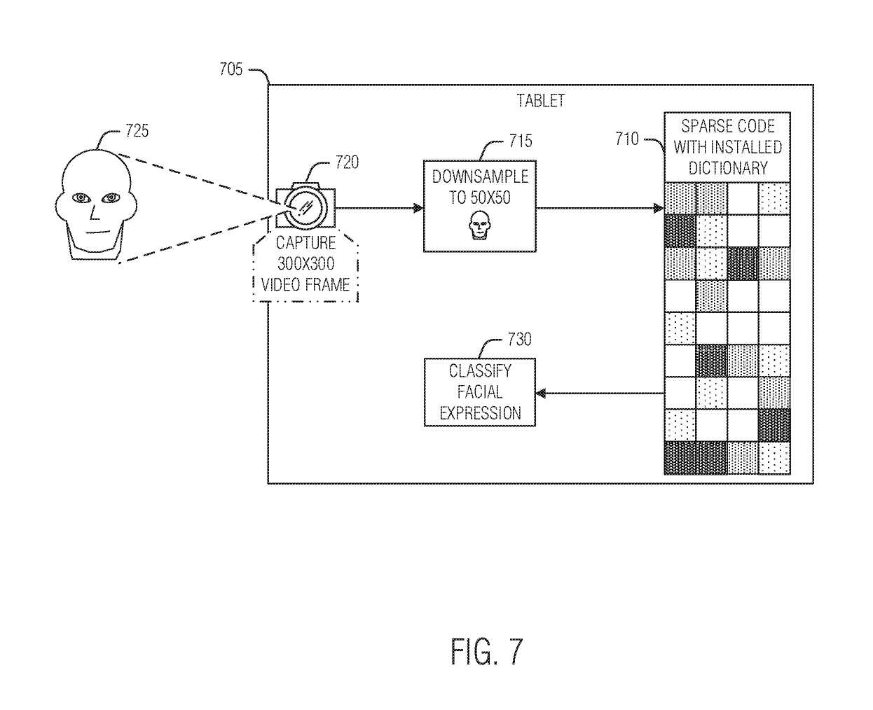

FIG. 7 illustrates a block diagram of an example of a system 705 using down sampled sensor data 715 to sparse code sensor data 710 and classify 730 the result, according to an embodiment. The subject 725 is captured by the sensor 720 at a particular data density (here a 300 pixel by 300-pixel video frame). The input is down sampled according to an entropic analysis (here to a 50×50 frame) prior to being sparse coded 710. As noted above, performing the down sampling prior to sparse coding 710 reduce processing time and complexity for the device 705. After the sparse coding 710 is complete, the device 705, or another entity (e.g., a cloud service), performs classification upon the feature space.

Dictionary pruning is another enhancement to sparse coding sensor devices to improve performance. Generally, the goal of dictionary training is to produce a high-quality dictionary by capturing as many relevant features as possible. This generally results in a large dictionary that may preclude real-time encoding on resource-constrained devices because encoding time is often proportional to the size of the dictionary. Dictionary pruning reduces the size of the dictionary and thus reduces encoding time.

Dictionary pruning may be achieved by sparse coding the training data with the dictionary. The frequency of use for each feature of the dictionary in the resultant sparse codes is calculated. The features are then ranked, from most frequently used to least frequently used. Pruning then starts with the lower ranked (e.g., least frequently used features) and moves towards the higher ranked features until a threshold is met. In an example, the threshold is a total dictionary size (e.g., a certain number of features). In an example, the threshold is an encoding time. Here, after each pruning (e.g., where one or more features are removed), the training set may be encoding again and timed. Pruning continues until the encoding time meets the threshold. Thus, the pruning process may be iterated automatically until the encoding speed meets a processing time (e.g., real-time) metric. This pruning technique allows the dictionary quality to gracefully degrade just enough to the match the capabilities of the device, but no less.

As mentioned above, down sampling sensor data may provide several benefits. However, in some circumstances, a data configuration (e.g., density, pixel arrangement, etc.) may be useful in later processing. To address this issue, super-resolution may be performed with sparse coded data as an intermediary. Super resolution involves reconstructing an output with greater resolution than the input that was sparse coded.

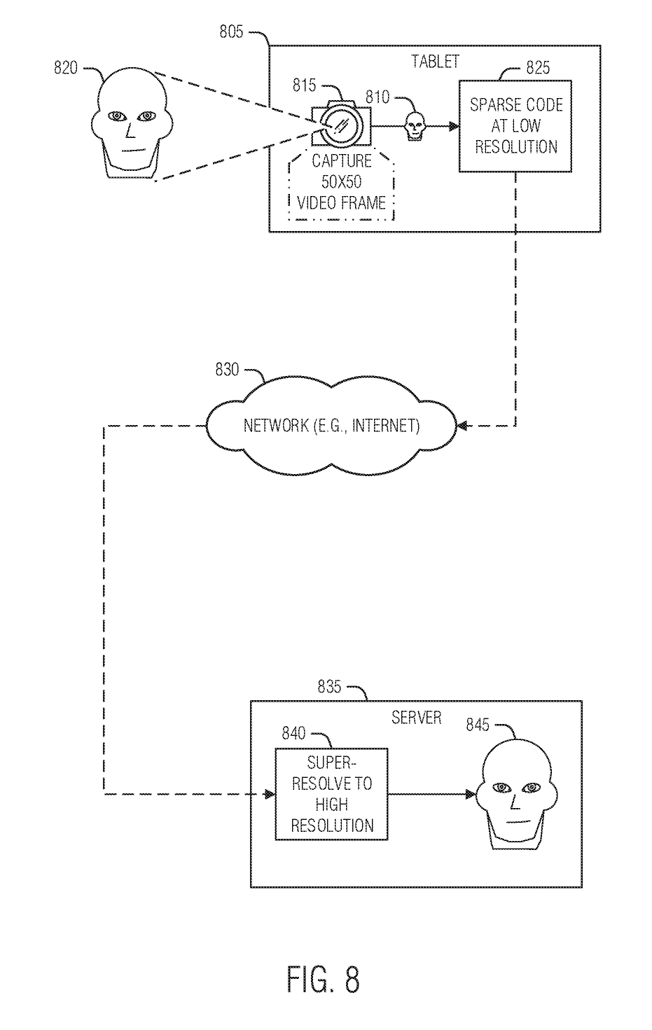

FIG. 8 illustrates a block diagram of an example of a system using sparse codes to create super-resolution sensor data, according to an embodiment. Here, a subject 820 is captured by a camera 815 at a first device 805. The sensor data 810 is captured, or down sampled, to a low resolution. An encoder 825 of the device 805 produces a sparse coded representation of the sensor data 810 and transmits the representation via a network 830 to a remote device 835. The remote device uses a decoder 840 that accepts the sparse coded representation and an output resolution (e.g., as parameters) and produces a super resolution 845 of the sensor data 810. This may be helpful, for example, if a facial classifier is trained against a resolution of 300×300 but the sensor data 810 is at a resolution of 50×50.

As noted above, sparse coding may provide transmission (e.g., network) benefits. IoT and sensor network systems performing machine learning tasks such as automatic feature extraction often backhaul computed results to a data center for further centralized processing. However, this is a challenge because such systems may produce high-volume and high-velocity outputs-often with real-time constraints—that may overwhelm network capabilities. To address this problem, the following are a variety of practical techniques for low-latency, network efficient backhauling of sparse codes over a wireless network. As above, a real-time task is one that completes in a defined time period for the job, such as under 33 ms from video of 30 frames-per-second.

As mentioned above, many sensor network applications backhaul data under tight timing and bandwidth constraints. To meet these constraints, the precision of sparse representation coefficients is adjusted based on application requirements. For example, because many machine learning problems of interest (e.g., classification or super-resolution) gracefully tolerate reduced precision, bandwidth savings may be realized with a controlled impact on application performance. Further, because sparse representations include a coefficient index—and the size of the coefficient index may be large for large dictionaries-index compression may be achieved with an adaptive arithmetic coding modified to address sparse coding indices. An efficient network protocol for transmitting sparse codes over a network may significantly reduce overheads for transmitting sparse feature data. For example, because a sparse code includes both coefficient values and coefficient indices, the size of coefficients may be reduced or the indices may be adaptively compressed. In an example, these technique permits the transmission of complex sensor data, such as an image, in one maximum transmission unit (MTU).

A naïve network protocol may simply transmit the sparse code z as a dense vector. This approach may be problematic, however. For example, given a modest dictionary size d=1024, with 64-bit floating point coefficients, a single sparse code z would be 1024 bytes*8 bytes, which is 8192 bytes, or at least six packets. Assuming one-way network latency to be 10 milliseconds, network routing time would violate a 33-millisecond real-time threshold (e.g., 10 milliseconds per packet multiplied by the six packets is 600 milliseconds). This simple calculation does not account for the likely additional overhead (e.g., protocol messaging and response time) to recover from dropped packets. Packing many sparse codes into one MTU (e.g., packet) will alleviate these issues.

First, transmitting a sparse code z amounts to sending two pieces of information in a network packet: the value of the non-zero coefficients; and corresponding dictionary indices in the vector. Reducing coefficient precision is a technique to more efficiently transmit the sparse code z. For many sparse coding applications, it is unnecessary to use 64-bit floating point precision for the sparse code coefficients. The precise precision varies by application. To address this flexibly, coefficients may be encoded in a fixed-point representation with a scaling factor determined by application requirements. In an example, the scaling factor is initially communicated by the sensor to a remote data sink (e.g., a server, cloud service, etc.) during an initial protocol handshake. The remote data sink may subsequently decode the fixed-point representation using the scaling factor. Experimental results on super resolution, which is in general less tolerant to reduced precision than other sparse coding application such as classification, suggest successful performance when the precision from 64-bits to 5-bits. This configuration permits around 12 times more coefficients to be transmitted in a packet than possible with the naïve protocol.

Index compression is another technique to more efficiently use network resources when transmitting sparse codes. Sparse code transmission includes sending both a coefficient value and a corresponding index into the dictionary. For a basic indexing technique, where each coefficient index is a log₂ (d) bit integer, has a total index size of kp log₂ (d) bits, where k is the sparsity and p is the total number of sparse codes in the payload (e.g., the number of patches being encoded per input image). To improve on this basic indexing scheme, all _{d}Cₖ possible combinations of indices may be considered and, to each, an arbitrary ordinal number is assigned. Here, a total storage of p log₂ (_{d}Cₖ) bits is used. For example, given d=4096, k=24, p=4, the basic indexing uses 144 bytes, whereas the improved indexing technique uses just 105 bytes, for a space savings of 27%. A reduction in space entails a corresponding reduction in the number of packets used to transmit the sparse code.

Bit space to represent sparse codes may also be reduced by compressing indices via arithmetic coding. A first technique to apply arithmetic coding to the indices is based on, for a given dictionary, certain features (e.g., a DC-like component) will be more frequently used than others. In this case, arithmetic coding is used to index these more “popular” (e.g. used) features by treating each feature as a symbol in a code book and deriving the distribution of symbol usage frequency from sparse coding the dictionary's training set. A second technique considers each of the _{d}Cₖ possible index combinations as a symbol in the code book. Again, the usage frequency distribution of these symbols is derived from sparse coding the dictionary's training set, here, for a given input's p patches, a sequence of p symbols is encoded using this codebook. This second technique is facilitated when there is abundant training data because determining the frequency distribution of sparse codes uses more samples than determining the frequency distribution of just the features.

Both techniques may additionally employ adaptive arithmetic coding, where the frequency distributions used by the code books are updated as new input instances are sparse coded over time. As the distributions are updated, they are propagated to decoding endpoints. In practice, arithmetic codes may be implemented as either floating points or integers, but the precision of these are platform or application dependent. For a given precision, there is often a maximum number of symbols that an arithmetic code may encode. If the number of symbols exceeds the maximum, encoding method may revert to the basic scheme outlined above. When transmitting these encodings, a flag in the packet header indicating the encoding method may be set.

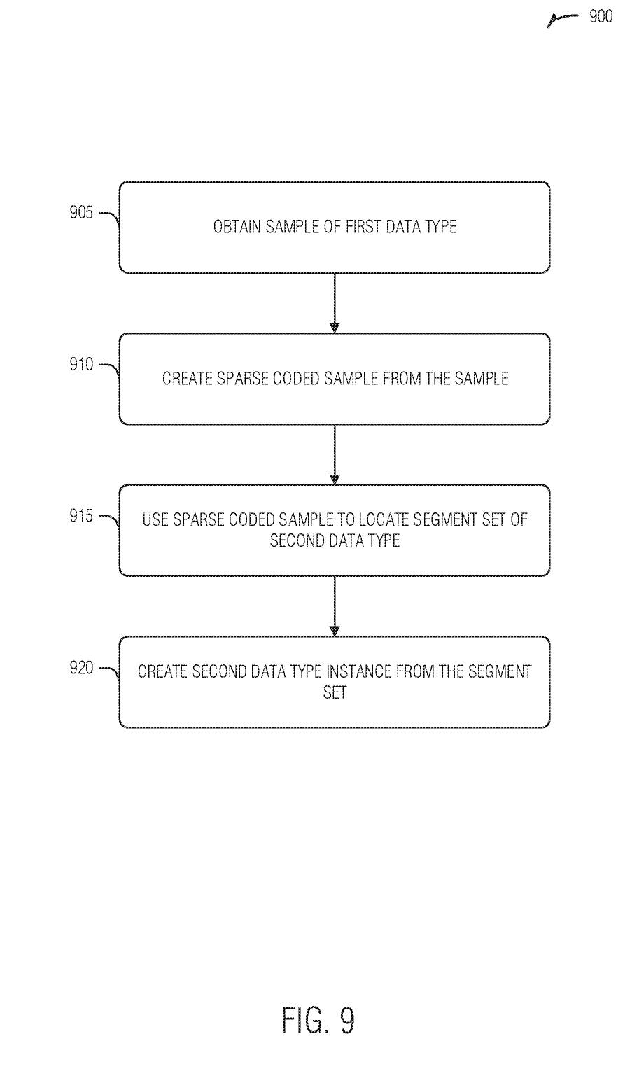

FIG. 9 illustrates a flow diagram of an example of a method 900 for sparse coding based classification, according to an embodiment. The operations of the method 900 are performed by electronic hardware, such as that described above or below.

At operation 905, a sample of a first type of data is obtained. In an example, the first type of data is produced by a first sensor. The first type of data is contrasted with a second type of data that is produced by a second sensor. In an example, the first sensor is a camera that produces a two-dimensional image. In an example, the two-dimensional image is a grayscale image. In an example, the second sensor is a depth camera that produces a depth image. In an example, the first sensor is a heart rate monitor. In an example, an original sample is down sampled to produce the sample. In an example, the down sampling is bounded by an entropic analysis of the first type of data.

At operation 910, the sample is encoded to create a sparse coded sample. In an example, the sparse coded sample includes a sparse code corresponding to patches of the sample. In an example, a patch of the patches is less than the sample. In an example, a first patch and a second patch of the patches overlap a same portion of the first sample without being equal to each other.

In an example, the sparse coded sample includes multiple sparse codes. In an example, a sparse code in the multiple sparse codes including a sparsity constraint. In an example, encoding the sample to create the sparse coded sample includes using OMP to create sparse codes for the sparse coded sample. In an example, encoding the sample to create the sparse coded sample includes using LARS to create sparse codes for the sparse coded sample.

At operation 915, a dataset is searched using the sparse coded sample to locate a segment set of a second type of data. In an example, the dataset has an upper bound on items contained therein.

In an example, the first sensor is deployed in a first device and obtaining the sample of a first type of data and encoding the sample to create a sparse coded sample are performed at the first device. In an example, searching the dataset using the sparse coded sample to locate a segment set of a second type of data and creating an instance of the second type of data using the segment set are created at a second device. In an example, the method 900 is extended to include transmitting the sparse coded sample from the first device to the second device.

In an example, the method 900 is extended to include obtaining a classification target and selecting a sparse code dictionary from several dictionaries based on the classification target. In an example, the sparse code dictionary is transmitted to the first device. Here, obtaining the classification target and selecting the data set occur remote from the first device. In an example, transmitting the sparse code dictionary to the first device includes transmitting a pre-computed Gram matrix for the sparse code dictionary to the first device.

In an example, encoding the sample to create the sparse coded sample includes using a spiking neural network (SNN) to create sparse codes for the sparse coded sample. In an example, the SNN is implemented in neurmorphic hardware of the first device. In an example, the SNN performs a Locally Competitive Algorithm (LCA) to solve a least absolute shrinkage and selection operator (LASSO) to create the sparse codes for the sparse code dictionary. In an example, the SNN includes a neuron for each entry in the dictionary arranged in a single fully connected layer. Here, each neuron includes an input, an output; and inhibitory outputs connected to other neurons.

In an example, searching the dataset using the sparse coded sample to locate the segment set includes comparing the sparse coded sample to sparse codes in the dataset to establish distances between the sparse coded sample and the sparse codes and filtering the sparse codes by the distances to identify a nearest neighbor set. In an example, an L1 norm is used to compare the sparse coded sample to sparse codes in the dataset to establish distances between the portion of the sparse coded sample and the sparse codes. In an example, a size of the nearest neighbor set has an upper bound.

In an example, the nearest neighbor set includes segments of the first type of data and corresponding segments of the second type of data. In an example, searching the dataset using the sparse coded sample to locate the segment set includes comparing a segment of the sample (not the sparse coded sample) to segments of the first type of data in the nearest neighbor set to identify a closest match. Once complete, a second type of data segment may be returned from the nearest neighbor set that corresponds to the closest match. In an example, comparing the segment of the sample to the segments of the first type of data in the nearest neighbor set to identify the closest match includes using an L2 norm to determine distances between the segment of the sample and the segments of the first type of data and selecting a member of the nearest neighbor set with a first type of data segment having the shortest distance.

At operation 920, an instance of the second type of data is created using the segment set.

The method 900 may be extended to train a dictionary. In an example, the dictionary training includes creating a first patch set for first type of data training data and creating a second patch set for second type of data training data, where each patch in the second patch set corresponds to a patch in the first patch set. Sparse codes for members of the first patch set may then be created. The data set may be created with a record for each member of the first patch set that includes a corresponding sparse code and member from the second patch set. In an example, the sparse code dictionary is trained from the first type of data training data. In an example, training the sparse code dictionary from the first type of data training data includes using K-SVD to create the dictionary. In an example, entries from the dictionary may be removed when a frequency of use in sparse coding falls below a threshold.

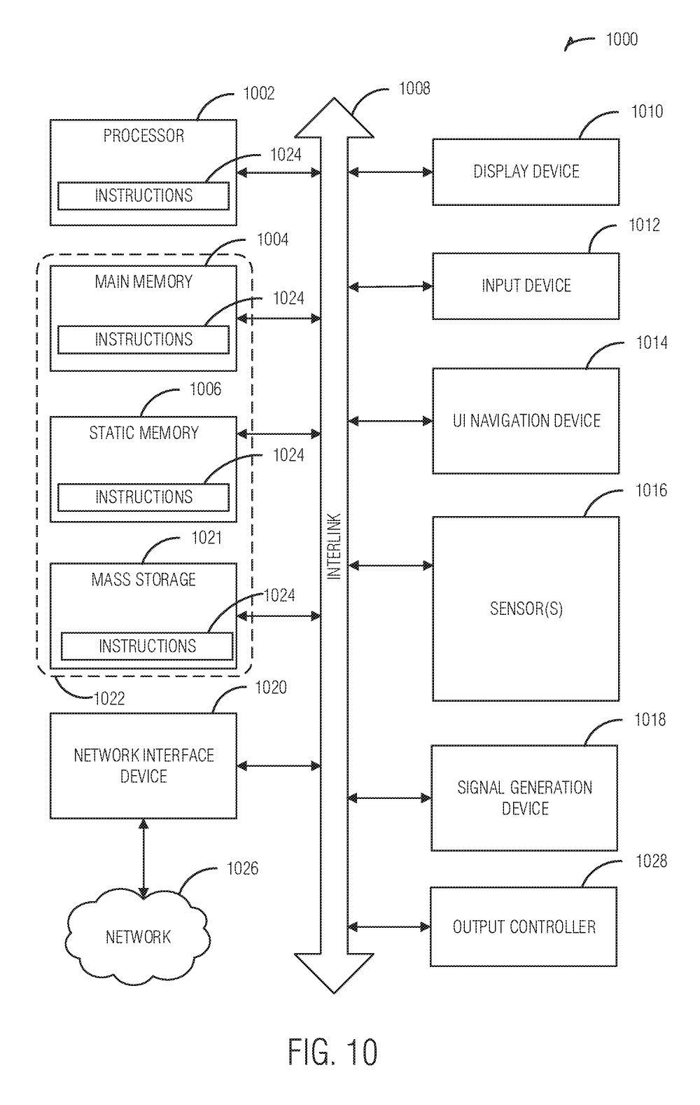

FIG. 10 illustrates a block diagram of an example machine 1000 upon which any one or more of the techniques (e.g., methodologies) discussed herein may perform. Examples, as described herein, may include, or may operate by, logic or a number of components, or mechanisms in the machine 1000. Circuitry (e.g., processing circuitry) is a collection of circuits implemented in tangible entities of the machine 1000 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1000 follow.

In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include my collection of machines that individually or jointly execute a set (or multiple sets) of instructions to perform any one or more of the methodologies discussed herein, such as cloud computing, software as a service (SaaS), other computer cluster configurations.

The machine 1000 (e.g., computer system) may include a hardware processor 1002 (e.g., a central processing unit (CPU), a graphics processing unit (GPU), a hardware processor core, or any combination thereof), a main memory 1004, a static memory (e.g., memory or storage for firmware, microcode, a basic-input-output (BIOS), unified extensible firmware interface (UEFI) 1006, etc.), and mass storage 1021 (e.g., hard drive, tape drive, flash storage, or other block devices) some or all of which may communicate with each other via an interlink (e.g., bus) 1008. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device 1016 (e.g., drive unit), a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1002, the main memory 1004, the static memory 1006, or the mass storage 1016 may be, or include, a machine readable medium 1022 on which is stored one or more sets of data structures or instructions 1024 (e.g., software) embodying or utilized by any one or more of the techniques or functions described herein. The instructions 1024 may also reside, completely or at least partially, within any of registers of the processor 1002, the main memory 1004, the static memory 1006, or the mass storage 1016 during execution thereof by the machine 1000. In an example, one or any combination of the hardware processor 1002, the main memory 1004, the static memory 1006, or the mass storage 1016 may constitute the machine readable media 1002. While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software. A transmission medium is a machine readable medium.

### Additional Notes & Examples

Example 1 is a system for sparse coding classification, the system comprising: an encoder, and processing circuitry configured by instructions from the system to: obtain a sample of a first type of data; encode, using the encoder, the sample to create a sparse coded sample; search a dataset using the sparse coded sample to locate a segment set of a second type of data; and create an instance of the second type of data using the segment set.

In Example 2, the subject matter of Example 1 includes, wherein the sparse coded sample includes a sparse code corresponding to patches of the sample.

In Example 3, the subject matter of Example 2 includes, wherein a patch of the patches is less than the sample.

In Example 4, the subject matter of Example 3 includes, wherein a first patch and a second patch of the patches overlap a same portion of the first sample without being equal to each other.

In Example 5, the subject matter of Examples 1-4 includes, wherein the sparse coded sample includes multiple sparse codes, a sparse code in the multiple sparse codes including a sparsity constraint.

In Example 6, the subject matter of Examples 1-5 includes, wherein, to encode the sample to create the sparse coded sample, the processing circuitry uses Orthogonal Matching Pursuit (OMP) to create sparse codes for the sparse coded sample.

In Example 7, the subject matter of Examples 1-6 includes, wherein, to encode the sample to create the sparse coded sample, the processing circuitry uses Least Angle Regression (LARS) to create sparse codes for the sparse coded sample.

In Example 8, the subject matter of Examples 1-7 includes, wherein the dataset has an upper bound on items contained therein.

In Example 9, the subject matter of Examples 14 includes, wherein, to search the dataset using the sparse coded sample to locate the segment set, the processing circuitry; compares the sparse coded sample to sparse codes in the dataset to establish distances between the sparse coded sample and the sparse codes; and filters the sparse codes by the distances to identify a nearest neighbor set.

In Example 10, the subject matter of Example 9 includes, wherein, to compare the sparse coded sample to sparse codes in the dataset to establish distances between the portion of the sparse coded sample and the sparse codes, the processing circuitry uses an L1 norm to determine distances.

In Example 11, the subject matter of Examples 9-10 includes, wherein the nearest neighbor set includes segments of the first type of data and corresponding segments of the second type of data.

In Example 12, the subject matter of Example 11 includes, wherein, to search the dataset using the sparse coded sample to locate the segment set, the processing circuitry; compares a segment of the sample to segments of the first type of data in the nearest neighbor set to identify a closest match; and returns a second type of data segment from the nearest neighbor set that corresponds to the closest match.

In Example 13, the subject matter of Example 12 includes, wherein, to compare the segment of the sample to the segments of the first type of data in the nearest neighbor set to identify the closest match, the processing circuitry; uses an L2 norm to determine distances between the segment of the sample and the segments of the first type of data; and selects a member of the nearest neighbor set with a first type of data segment having the shortest distance.

In Example 14, the subject matter of Examples 9-13 includes, wherein a size of the nearest neighbor set has an upper bound.

In Example 15, the subject matter of Examples 1-14 includes, wherein the first type of data is produced by a first sensor and the second type of data is produced by a second sensor.

In Example 16, the subject matter of Example 15 includes, wherein the first sensor is a camera that produces a two-dimensional image.

In Example 17, the subject matter of Example 16 includes, wherein the two-dimensional image is a grayscale image.

In Example 18, the subject matter of Examples 15-17 includes, wherein the second sensor is a depth camera that produces a depth image.

In Example 19, the subject matter of Examples 15-18 includes, wherein the first sensor is a heart rate monitor.

In Example 20, the subject matter of Examples 15-19 includes, wherein the first sensor is deployed in a first device, wherein a first portion of the processing circuitry to obtain the sample of a first type of data and encode the sample to create a sparse coded sample, is at the first device, and wherein a second portion of the processing circuitry to search the dataset using the sparse coded sample to locate a segment set of a second type of data and create an instance of the second type of data using the segment set is at a second device.

In Example 21, the subject matter of Example 20 includes, wherein the processing circuitry is configured by the instructions to: obtain a classification target; and select a sparse code dictionary from several dictionaries based on the classification target.

In Example 22, the subject matter of Example 21 includes, wherein the processing circuitry is configured by the instructions to transmit the sparse code dictionary to the first device, wherein obtaining the classification target and selecting the data set occur remote from the first device.

In Example 23, the subject mater of Example 22 includes, wherein, to transmit the sparse code dictionary to the first device, the processing circuitry transmits a pre-computed gram matrix for the sparse code dictionary to the first device.

In Example 24, the subject matter of Examples 21-23 includes, wherein, to encode the sample to create the sparse coded sample, the encode is a spiking neural network (SNN) to create sparse codes for the sparse coded sample.

In Example 25, the subject matter of Example 24 includes, wherein the SNN performs a Locally Competitive Algorithm (LCA) to solve a least absolute shrinkage and selection operator (LASSO) to create the sparse codes for the sparse code dictionary.

In Example 26, the subject matter of Example 25 includes, wherein the SNN includes a neuron for each entry in the sparse code dictionary arranged in a single fully connected layer, each neuron including an input, an output, and inhibitory outputs connected to other neurons.

In Example 27, the subject matter of Examples 24-26 includes, wherein the SNN is implemented in neuromorphic hardware of the first device.

In Example 28, the subject matter of Examples 20-27 includes, wherein the processing circuitry is configured by the instructions to transmit the sparse coded sample from the first device to the second device.

In Example 29, the subject matter of Examples 1-28 includes, wherein the processing circuitry is configured by the instructions to: create a first patch set for first type of data training data; create a second patch set for second type of data training data, each patch in the second patch set corresponding to a patch in the first patch set; create sparse codes for members of the first patch set; and create the data set with a record for each member of the first patch set that includes a corresponding sparse code and member from the second patch set.

In Example 30, the subject matter of Example 29 includes, wherein the processing circuitry is configured by the instructions to train a sparse code dictionary from the first type of data training data.

In Example 31, the subject matter of Example 30 includes, wherein, to train the sparse code dictionary from the first type of data training data, the processing circuitry uses K-SVD to create the sparse code dictionary.

In Example 32, the subject matter of Example 31 includes, wherein the processing circuitry is configured by the instructions to remove entries from the sparse code dictionary when a frequency of use in sparse coding falls below a threshold.

In Example 33, the subject matter of Examples 1-32 includes, wherein the processing circuitry is configured by the instructions to downsample an original sample to produce the sample.

In Example 34, the subject matter of Example 33 includes, wherein downsampling is bounded by an entropic analysis of the first type of data.

Example 35 is a method for sparse coding classification, the method comprising: obtaining a sample of a first type of data; encoding the sample to create a sparse coded sample; searching a dataset using the sparse coded sample to locate a segment set of a second type of data; and creating an instance of the second type of data using the segment set.

In Example 36, the subject matter of Example 35 includes, wherein the sparse coded sample includes a sparse code corresponding to patches of the sample.

In Example 37, the subject matter of Example 36 includes, wherein a patch of the patches is less than the sample.

In Example 38, the subject matter of Example 37 includes, wherein a first patch and a second patch of the patches overlap a same portion of the first sample without being equal to each other.

In Example 39, the subject matter of Examples 35-38 includes, wherein the sparse coded sample includes multiple sparse codes, a sparse code in the multiple sparse codes including a sparsity constraint.

In Example 40, the subject matter of Examples 35-39 includes, wherein encoding the sample to create the sparse coded sample includes using Orthogonal Matching Pursuit (OMP) to crease sparse codes for the sparse coded sample.

In Example 41, the subject matter of Examples 35-40 includes, wherein encoding the sample to create the sparse coded sample includes using Least Angle Regression (LARS) to create sparse codes for the sparse coded sample.

In Example 42, the subject matter of Examples 35-41 includes, wherein the dataset has an upper bound on items contained therein.

In Example 43, the subject matter of Examples 35-42 includes, wherein searching the dataset using the sparse coded sample to locate the segment set includes: comparing the sparse coded sample to sparse codes in the dataset to establish distances between the sparse coded sample and the sparse codes; and filtering the sparse codes by the distances to identify a nearest neighbor set.

In Example 44, the subject matter of Example 43 includes, wherein comparing the sparse coded sample to sparse codes in the dataset to establish distances between the portion of the sparse coded sample and the sparse codes includes using an L1 norm to determine distances.

In Example 45, the subject matter of Examples 43-44 includes, wherein the nearest neighbor set includes segments of the first type of data and corresponding segments of the second type of data.

In Example 46, the subject matter of Example 45 includes, wherein searching the dataset using the sparse coded sample to locate the segment set includes: comparing a segment of the sample to segments of the first type of data in the nearest neighbor set to identify a closest match; and returning a second type of data segment from the nearest neighbor set that corresponds to the closest match.

In Example 47, the subject matter of Example 46 includes, wherein comparing the segment of the sample to the segments of the first type of data in the nearest neighbor set to identify the closest match includes: using an L2 norm to determine distances between the segment of the sample and the segments of the first type of data; and selecting a member of the nearest neighbor set with a first type of data segment having the shortest distance.

In Example 48, the subject matter of Examples 43-47 includes, wherein a size of the nearest neighbor set has an upper bound.

In Example 49, the subject matter of Examples 35-48 includes, wherein the first type of data is produced by a first sensor and the second type of data is produced by a second sensor.

In Example 50, the subject matter of Example 49 includes, wherein the first sensor is a camera that produces a two-dimensional image.

In Example 51, the subject matter of Example 50 includes, wherein the two-dimensional image is a grayscale image.

In Example 52, the subject matter of Examples 49-51 includes, wherein the second sensor is a depth camera that produces a depth image.

In Example 53, the subject matter of Examples 49-52 includes, wherein the first sensor is a heart rate monitor.

In Example 54, the subject matter of Examples 49-53 includes, wherein the first sensor is deployed in a first device, wherein obtaining the sample of a first type of data and encoding the sample to create a sparse coded sample, are performed at the first device, and wherein searching the dataset using the sparse coded sample to locate a segment set of a second type of data and creating an instance of the second type of data using the segment set are performed at a second device.

In Example 55, the subject matter of Example 54 includes, obtaining a classification target; and selecting a sparse code dictionary from several dictionaries based on the classification target.

In Example 56, the subject matter of Example 55 includes, transmitting the sparse code dictionary to the first device, wherein obtaining the classification target and selecting the data set occur remote from the first device.

In Example 57, the subject matter of Example 56 includes, wherein transmitting the sparse code dictionary to the first device includes transmitting a pre-computed gram matrix for the sparse code dictionary to the first device.

In Example 58, the subject matter of Examples 55-57 includes, wherein encoding the sample to create the sparse coded sample includes using a spiking neural network (SNN) to create sparse codes for the sparse coded sample.

In Example 59, the subject matter of Example 58 includes, wherein the SNN performs a Locally Competitive Algorithm (LCA) to solve a least absolute shrinkage and selection operator (LASSO) to create the sparse codes for the sparse code dictionary.

In Example 60, the subject matter of Example 59 includes, wherein the SNN includes a neuron for each entry in the sparse code dictionary arranged in a single fully connected layer, each neuron including an input, an output, and inhibitory outputs connected to other neurons.

In Example 61, the subject matter of Examples 58-60 includes, wherein the SNN is implemented in neuromorphic hardware of the first device.

In Example 62, the subject matter of Examples 54-61 includes, transmitting the sparse coded sample from the first device to the second device.

In Example 63, the subject matter of Examples 35-62 includes, creating a first patch set for first type of data training data; creating a second patch set for second type of data training data, each patch in the second patch set corresponding to a patch in the first patch set; creating sparse codes for members of the first patch set; and creating the data set with a record for each member of the first patch set that includes a corresponding sparse code and member from the second patch set.

In Example 64, the subject matter of Example 63 includes, training a sparse code dictionary from the first type of data training data.

In Example 65, the subject matter of Example 64 includes, wherein training the sparse code dictionary from the first type of data training data includes using K-SVD to create the sparse code dictionary.

In Example 66, the subject matter of Example 65 includes, removing entries from the sparse code dictionary when a frequency of use in sparse coding falls below a threshold.

In Example 67, the subject matter of Examples 35-66 includes, downsampling an original sample to produce the sample.

In Example 68, the subject matter of Example 67 includes, wherein the downsampling is bounded by an entropic analysis of the first type of data.

Example 69 is at least one machine readable medium including instructions that, when executed by processing circuitry, cause the processing circuitry to perform any method of Examples 35-68.

Example 70 is a system comprising means to perform any method of Examples 35-68.

Example 71 is at least one machine readable medium including instructions for sparse coding classification, the instructions, when executed by processing circuitry, cause the processing circuitry to perform operations comprising: obtaining a sample of a first type of data; encoding the sample to create a sparse coded sample; searching a dataset using the sparse coded sample to locate a segment set of a second type of data; and creating an instance of the second type of data using the segment set.

In Example 72, the subject matter of Example 71 includes, wherein the sparse coded sample includes a sparse code corresponding to patches of the sample.

In Example 73, the subject matter of Example 72 includes, wherein a patch of the patches is less than the sample.

In Example 74, the subject matter of Example 73 includes, wherein a first patch and a second patch of the patches overlap a same portion of the first sample without being equal to each other.

In Example 75, the subject matter of Examples 71-74 includes, wherein the sparse coded sample includes multiple sparse codes, a sparse code in the multiple sparse codes including a sparsity constraint.

In Example 76, the subject matter of Examples 71-75 includes, wherein encoding the sample to create the sparse coded sample includes using Orthogonal Matching Pursuit (OMP) to create sparse codes for the sparse coded sample.

In Example 77, the subject matter of Examples 71-76 includes, wherein encoding the sample to create the sparse coded sample includes using Least Angle Regression (LARS) to create sparse codes for the sparse coded sample.

In Example 78, the subject matter of Examples 71-77 includes, wherein the dataset has an upper bound on items contained therein.

In Example 79, the subject matter of Examples 71-78 includes, wherein searching the dataset using the sparse coded sample to locate the segment set includes: comparing the sparse coded sample to sparse codes in the dataset to establish distances between the sparse coded sample and the sparse codes; and filtering the sparse codes by the distances to identify a nearest neighbor set.

In Example 80, the subject matter of Example 79 includes, wherein comparing the sparse coded sample to sparse codes in the dataset to establish distances between the portion of the sparse coded sample and the sparse codes includes using an L1 norm to determine distances.

In Example 81, the subject matter of Examples 79-80 includes, wherein the nearest neighbor set includes segments of the first type of data and corresponding segments of the second type of data.

In Example 82, the subject matter of Example 81 includes, wherein searching the dataset using the sparse coded sample to locate the segment set includes: comparing a segment of the sample to segments of the first type of data in the nearest neighbor set to identify a closest match; and returning a second type of data segment from the nearest neighbor set that corresponds to the closest match.

In Example 83, the subject matter of Example 82 includes, wherein comparing the segment of the sample to the segments of the first type of data in the nearest neighbor set to identify the closest match includes: using an L2 norm to determine distances between the segment of the sample and the segments of the first type of data; and selecting a member of the nearest neighbor set with a first type of data segment having the shortest distance.

In Example 84, the subject matter of Examples 79-83 includes, wherein a size of the nearest neighbor set has an upper bound.

In Example 85, the subject matter of Examples 71-84 includes, wherein the first type of data is produced by a first sensor and the second type of data is produced by a second sensor.

In Example 86, the subject matter of Example 85 includes, wherein the first sensor is a camera that produces a two-dimensional image.

In Example 87, the subject matter of Example 86 includes, wherein the two-dimensional image is a grayscale image.

In Example 88, the subject matter of Examples 85-87 includes, wherein the second sensor is a depth camera that produces a depth image.

In Example 89, the subject matter of Examples 85-88 includes, wherein the first sensor is a heart rate monitor.

In Example 90, the subject matter of Examples 85-89 includes, wherein the first sensor is deployed in a first device, wherein obtaining the sample of a first type of data and encoding the sample to create a sparse coded sample, are performed at the first device, and wherein searching the dataset using the sparse coded sample to locate a segment set of a second type of data and creating an instance of the second type of data using the segment set are performed at a second device.

In Example 91, the subject matter of Example 90 includes, wherein the operations comprise: obtaining a classification target; and selecting a sparse code dictionary from several dictionaries based on the classification target.

In Example 92, the subject matter of Example 91 includes, wherein the operations comprise transmitting the sparse code dictionary to the first device, wherein obtaining the classification target and selecting the data set occur remote from the first device.

In Example 93, the subject matter of Example 92 includes, wherein transmitting the sparse code dictionary to the first device includes transmitting a pre-computed gram matrix for the sparse code dictionary to the first device.

In Example 94, the subject matter of Examples 91-93 includes, wherein encoding the sample to create the sparse coded sample includes using a spiking neural network (SNN) to create sparse codes for the sparse coded sample.

In Example 95, the subject matter of Example 94 includes, wherein the SNN performs a Locally Competitive Algorithm (LCA) to solve a least absolute shrinkage and selection operator (LASSO) to create the sparse codes for the sparse code dictionary.

In Example 96, the subject matter of Example 95 includes, wherein the SNN includes a neuron for each entry in the sparse code dictionary arranged in a single fully connected layer, each neuron including an input, an output, and inhibitory outputs connected to other neurons.

In Example 97, the subject matter of Examples 94-96 includes, wherein the SNN is implemented in neuromorphic hardware of the first device.

In Example 98, the subject matter of Examples 90-97 includes, wherein the operations comprise transmitting the sparse coded sample from the first device to the second device.

In Example 99, the subject matter of Examples 71-98 includes, wherein the operations comprise: creating a first patch set for first type of data training data; creating a second patch set for second type of data training data, each patch in the second patch set corresponding to a patch in the first patch set; creating sparse codes for members of the first patch set; and creating the data set with a record for each member of the first patch set that includes a corresponding sparse code and member from the second patch set.

In Example 100, the subject matter of Example 99 includes, wherein the operations comprise training a sparse code dictionary from the first type of data training data.

In Example 101, the subject matter of Example 100 includes, wherein training the sparse code dictionary from the first type of data training data includes using K-SVD to create the sparse code dictionary.

In Example 102, the subject matter of Example 101 includes, wherein the operations comprise removing entries from the sparse code dictionary when a frequency of use in sparse coding falls below a threshold.

In Example 103, the subject matter of Examples 71-102 includes, wherein the operations comprise downsampling an original sample to produce the sample.

In Example 104, the subject matter of Example 103 includes, wherein the downsampling is bounded by an entropic analysis of the first type of data.

Example 105 is a system for sparse coding classification, the system comprising: means for obtaining a sample of a first type of data; means for encoding the sample to create a sparse coded sample; means for searching a dataset using the sparse coded sample to locate a segment set of a second type of data; and means for creating an instance of the second type of data using the segment set.

In Example 106, the subject matter of Example 105 includes, wherein the sparse coded sample includes a sparse code corresponding to patches of the sample.

In Example 107, the subject matter of Example 106 includes, wherein a patch of the patches is less than the sample.

In Example 108, the subject matter of Example 107 includes, wherein a first patch and a second patch of the patches overlap a same portion of the first sample without being equal to each other.

In Example 109, the subject matter of Examples 105-108 includes, wherein the sparse coded sample includes multiple sparse codes, a sparse code in the multiple sparse codes including a sparsity constraint.

In Example 110, the subject matter of Examples 105-109 includes, wherein the means for encoding the sample to create the sparse coded sample include means for using Orthogonal Matching Pursuit (OMP) to create sparse codes for the sparse coded sample.

In Example 111, the subject matter of Examples 105-110 includes, wherein the means for encoding the sample to create the sparse coded sample include means for using Least Angle Regression (LARS) to create sparse codes for the sparse coded sample.

In Example 112, the subject matter of Examples 105-111 includes, wherein the dataset has an upper bound on items contained therein.

In Example 113, the subject matter of Examples 105-112 includes, wherein the means for searching the dataset using the sparse coded sample to locate the segment set include: means for comparing the sparse coded sample to sparse codes in the dataset to establish distances between the sparse coded sample and the sparse codes; and means for filtering the spare codes by the distances to identify a nearest neighbor set.

In Example 114, the subject matter of Example 113 includes, wherein the means for comparing the sparse coded sample to sparse codes in the dataset to establish distances between the portion of the sparse coded sample and the sparse codes include means for using an L1 norm to determine distances.

In Example 115, the subject matter of Examples 113-114 includes, wherein the nearest neighbor set includes segments of the first type of data and corresponding segments of the second type of data.

In Example 116, the subject matter of Example 115 includes, wherein the means for searching the dataset using the sparse coded sample to locate the segment set include: means for comparing a segment of the sample to segments of the first type of data in the nearest neighbor set to identify a closest match; and means for returning a second type of data segment from the nearest neighbor set that corresponds to the closest match.

In Example 117, the subject matter of Example 116 includes, wherein the means for comparing the segment of the sample to the segments of the first type of data in the nearest neighbor set to identify the closest match include: means for using an L2 norm to determine distances between the segment of the sample and the segments of the first type of data; and means for selecting a member of the nearest neighbor set with a first type of data segment having the shortest distance.

In Example 118, the subject matter of Examples 113-117 includes, wherein a size of the nearest neighbor set has an upper bound.

In Example 119, the subject matter of Examples 105-118 includes, wherein the first type of data is produced by a first sensor and the second type of data is produced by a second sensor.

In Example 120, the subject matter of Example 119 includes, wherein the first sensor is a camera that produces a two-dimensional image.

In Example 121, the subject matter of Example 120 includes, wherein the two-dimensional image is a grayscale image.

In Example 122, the subject matter of Examples 119-121 includes, wherein the second sensor is a depth camera that produces a depth image.

In Example 123, the subject matter of Examples 119-122 includes, wherein the first sensor is a heart rate monitor.

In Example 124, the subject matter of Examples 119-123 includes, wherein the first sensor is deployed in a first device, wherein the means for obtaining the sample of a first type of data and the means for encoding the sample to create a sparse coded sample, are at the first device, and wherein the means for searching the dataset using the sparse coded sample to locate a segment set of a second type of data and the means for creating an instance of the second type of data using the segment set are at a second device.

In Example 125, the subject matter of Example 124 includes, means for obtaining a classification target; and means for selecting a sparse code dictionary from several dictionaries based on the classification target.

In Example 126, the subject matter of Example 125 includes, means for transmitting the sparse code dictionary to the first device, wherein obtaining the classification target and selecting the data set occur remote from the first device.

In Example 127, the subject matter of Example 126 includes, wherein the means for transmitting the sparse code dictionary to the first device include means for transmitting a pre-computed gram matrix for the sparse code dictionary to the first device.

In Example 128, the subject matter of Examples 125-127 includes, wherein the means for encoding the sample to create the sparse coded sample include means for using a spiking neural network (SNN) to create sparse codes for the sparse coded sample.

In Example 129, the subject matter of Example 128 includes, wherein the SNN performs a Locally Competitive Algorithm (LCA) to solve a least absolute shrinkage and selection operator (LASSO) to create the sparse codes for the sparse code dictionary.

In Example 130, the subject matter of Example 129 includes, wherein the SNN includes a neuron for each entry in the sparse code dictionary arranged in a single fully connected layer, each neuron including an input, an output, and inhibitory outputs connected to other neurons.

In Example 131, the subject matter of Examples 128-130 includes, wherein the SNN is implemented in neuromorphic hardware of the first device.

In Example 132, the subject matter of Examples 124-131 includes, means for transmitting the sparse coded sample from the first device to the second device.

In Example 133, the subject matter of Examples 105-132 includes, means for creating a first patch set for first type of data training data; means for creating a second patch set for second type of data training data, each patch in the second patch set corresponding to a patch in the first patch set; means for creating sparse codes for members of the first patch set; and means for creating the data set with a record for each member of the first patch set that includes a corresponding sparse code and member from the second patch set.

In Example 134, the subject matter of Example 133 includes, means for training a sparse code dictionary from the first type of data training data.

In Example 135, the subject matter of Example 134 includes, wherein the means for training the sparse code dictionary from the first type of data training data include means for using K-SVD to create the sparse code dictionary.

In Example 136, the subject matter of Example 135 includes, means for removing entries from the sparse code dictionary when a frequency of use in sparse coding falls below a threshold.

In Example 137, the subject matter of Examples 105-136 includes, means for downsampling an original sample to produce the sample.

In Example 138, the subject matter of Example 137 includes, wherein the downsampling is bounded by an entropic analysis of the first type of data.

Example 139 is at least one machine-readable medium including instructions that, when executed by processing circuitry, cause the processing circuitry to perform operations to implement of any of Examples 1-138.

Example 140 is an apparatus comprising means to implement of any of Examples 1-138.

Example 141 is a system to implement of any of Examples 1-138.

Example 142 is a method to implement of any of Examples 1-138.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the fill scope of equivalents to which such claims are entitled.

What is claimed is:

1. A system for sparse coding classification, the system comprising:
an encoder; and
processing circuitry configured by instructions from the system to:
obtain a sample of a first type of data;
encode, using the encoder, the sample to create a sparse coded sample;
search a dataset using the sparse coded sample to locate a segment set of a second type of data; and
create an instance of the second type of data using the segment set.

2. The system of claim 1, wherein the sparse coded sample includes a sparse code corresponding to patches of the sample.

3. The system of claim 1, wherein, to search the dataset using the sparse coded sample to locate the segment set, the processing circuitry:
compares the sparse coded sample to sparse codes in the dataset to establish distances between the sparse coded sample and the sparse codes; and
filters the sparse codes by the distances to identify a nearest neighbor set.

4. The system of claim 3, wherein the nearest neighbor set includes segments of the first type of data and corresponding segments of the second type of data.

5. The system of claim 1, wherein the first type of data is produced by a first sensor and the second type of data is produced by a second sensor.

6. The system of claim 5, wherein the first sensor is deployed in a first device, wherein a first portion of the processing circuitry to obtain the sample of a first type of data and encode the sample to create a sparse coded sample, is at the first device, and wherein a second portion of the processing circuitry to search the dataset using the sparse coded sample to locate a segment set of a second type of data and create an instance of the second type of data using the segment set is at a second device.

7. The system of claim 6, wherein the processing circuitry is configured by the instructions to:
obtain a classification target; and
select a sparse code dictionary from several dictionaries based on the classification target.

8. The system of claim 7, wherein, to encode the sample to create the sparse coded sample, the encode is a spiking neural network (SNN) to create sparse codes for the sparse coded sample.

9. A method for sparse coding classification, the method comprising:
obtaining a sample of a first type of data;
encoding the sample to create a sparse coded sample;
searching a dataset using the sparse coded sample to locate a segment set of a second type of data; and
creating an instance of the second type of data using the segment set.

10. The method of claim 9, wherein the sparse coded sample includes a sparse code corresponding to patches of the sample.

11. The method of claim 9, wherein searching the dataset using the sparse coded sample to locate the segment set includes:
comparing the sparse coded sample to sparse codes in the dataset to establish distances between the sparse coded sample and the sparse codes; and
filtering the sparse codes by the distances to identify a nearest neighbor set.

12. The method of claim 11, wherein the nearest neighbor set includes segments of the first type of data and corresponding segments of the second type of data.

13. The method of claim 9, wherein the first type of data is produced by a first sensor and the second type of data is produced by a second sensor.

14. The method of claim 13, wherein the first sensor is deployed in a first device, wherein obtaining the sample of a first type of data and encoding the sample to create a sparse coded sample, are performed at the first device, and wherein searching the dataset using the sparse coded sample to locate a segment set of a second type of data and creating an instance of the second type of data using the segment set are performed at a second device.

15. The method of claim 14 comprising:
obtaining a classification target; and
selecting a sparse code dictionary from several dictionaries based on the classification target.

16. The method of claim 15, wherein encoding the sample to create the sparse coded sample includes using a spiking neural network (SNN) to create sparse codes for the sparse coded sample.

17. At least one machine readable medium including instructions for sparse coding classification, the instructions, when executed by processing circuitry, cause the processing circuitry to perform operations comprising:
obtaining a sample of a first type of data;
encoding the sample to create a sparse coded sample;
searching a dataset using the sparse coded sample to locate a segment set of a second type of data; and
creating an instance of the second type of data using the segment set.

18. The at least one machine readable medium of claim 17, wherein the sparse coded sample includes a sparse code corresponding to patches of the sample.

19. The at least one machine readable medium of claim 17, wherein searching the dataset using the sparse coded sample to locate the segment set includes:
comparing the sparse coded sample to sparse codes in the dataset to establish distances between the sparse coded sample and the sparse codes; and
filtering the sparse codes by the distances to identify a nearest neighbor set.

20. The at least one machine readable medium of claim 19, wherein the nearest neighbor set includes segments of the first type of data and corresponding segments of the second type of data.

21. The at least one machine readable medium of claim 17, wherein the first type of data is produced by a first sensor and the second type of data is produced by a second sensor.

22. The at least one machine readable medium of claim 21, wherein the first sensor is deployed in a first device, wherein obtaining the sample of a first type of data and encoding the sample to create a sparse coded sample, are performed at the first device, and wherein searching the dataset using the sparse coded sample to locate a segment set of a second type of data and creating an instance of the second type of data using the segment set are performed at a second device.

23. The at least one machine readable medium of claim 22, wherein the operations comprise:
obtaining a classification target; and
selecting a sparse code dictionary from several dictionaries based on the classification target.

24. The at least one machine readable medium of claim 23, wherein encoding the sample to create the sparse coded sample includes using a spiking neural network (SNN) to create sparse codes for the sparse coded sample.
